(19) United States
(12) Patent Application Publication
(10) Pub. No.: US 2016/0142276 A1
(43) Pub. Date: May 19, 2016

(54) COMMUNICATION SYSTEM, MANAGMENT SERVER, AND MONITORING APPARATUS

(71) Applicant: HITACHI, LTD., Tokyo (JP)

(72) Inventors: Yusuke SHOMURA, Tokyo (JP); Rintaro KATAYAMA, Tokyo (JP); Seiya KUDOH, Tokyo (JP)

(73) Assignee: HITACHI, LTD., Tokyo (JP)

(21) Appl. No.: 14/936,869

(22) Filed: Nov. 10, 2015

(30) Foreign Application Priority Data
Nov. 13, 2014 (JP) 2014-230572

(51) Int. Cl. H04L 12/26; H04L 29/08

(52) U.S. Cl. CPC H04L 43/10; H04L 67/14; H04L 43/06

(57) ABSTRACT

It is provided a communication system comprising: a first monitoring apparatus configured to monitor a control signal related to a connection request between a network and a terminal, and generate a reception log; a second monitoring apparatus configured to monitor a packet inputted/outputted to/from a gateway apparatus configured to transfer user data, sort the packet for each session, identify a type of an application which generates the session, and generate a session log including the type of an application; and a traffic management server configured to acquire the reception log generated by the first monitoring apparatus and the session log generated by the second monitoring apparatus, correlate the reception log with the session log by using an occurrence time of the reception log, an occurrence time of the session log, and an identifier of the terminal, and identify an application related to a session which generated the control signal.

### CLAIM OF PRIORITY

The present application claims priority from Japanese patent application JP 2014-230572 filed on Nov. 13, 2014, the content of which is hereby incorporated by reference into this application.

### BACKGROUND

Present invention is related to a communication system configured to transfer user data.

With the increase in popularity of smart phones, various applications, such as those for video streaming, games, SNS (Social Networking Service), IM (Instant Messenger), or the like, are used in cellular communication systems. Some of the applications used in smart phones require permanent connection, which needs frequent connections to the cellular communication system. Also, some applications request a large number of users to be connected to the system simultaneously for some of the activities of the applications, requiring a large number of users to update information of the applications. When such connection requests occur simultaneously, signal bursts are generated where a large number of signalings occur at the core network of the cellular communication system for a short and specific period of time. When such signaling bursts are generated the core network apparatus will be overloaded, which may prevent the users from being connected to the cellular communication system and affect the service provided by the cellular communication system.

In order to prevent the cellular communication system from being affected by the signaling bursts, mobile network operators occasionally identify the applications that generate the signaling bursts and request the developers of such applications for improvement.

As the background of this technology field, JP 2014-78894 A has been available. According to JP 2014-78894 A, as a management apparatus, the service control unit of the management apparatus acquires the information related to the correlation between the information of multiple terminals, comprising a first group under the control of a base station, with the information which indicates the application implemented by each terminal in the first group. A communication system in which an aggregation control unit selects based on the acquired correlation multiple terminals which comprise a second group in which an application that is under the control the base station and of the same type is implemented has been disclosed.

### SUMMARY

For cellular communication systems, as a method to identify a terminal that generates a signaling for connection request and a method to identify an application which generated the traffic of transmission and reception for a terminal, there is a method to acquire and analyze by a probe apparatus the signaling information and/or the traffic information of a core network. For example, it is possible to acquire signaling information in LTE (Long Term Evolution) which is standardized in 3GPP (3rd Generation Partnership Project) by having a probe apparatus monitor the S1-MME, which in an interface between eNodeB and MME (Mobility Management Entity), and the S11, which is an interface between MME and S-GW. Also, it is possible to acquire the traffic information by having a probe apparatus monitor the S1-U, which is an interface between eNodeB (E-UTRAN NodeB) and S-GW (Serving Gateway), and the SGi, which is an interface between PDN (Packet Data Network) and P-GW (PDN Gateway).

From the obtained signaling information, the terminal which requested connection to the network and time when the request was made can be acquired. Also, by acquiring from the traffic information address, port number, data pattern included during a payload, and traffic pattern, an application can be identified.

Analysis of combining these pieces of information (i.e., an attempt to identify the application which generated a signaling) will require the signaling information and the traffic information to be inputted into a single prove. However, since the signaling and the traffic are completely separate from one another in LTE, inputting the signaling information and the traffic information of a single terminal into a single prove is taxing.

Accordingly, a technique to identify and visualize the application which generated the signaling for the entire cellular communication system is in demand.

The representative one of inventions disclosed in this application is outlined as follows. There is provided a communication system comprising: a first monitoring apparatus configured to monitor a control signal related to a connection request between a network and a terminal, and generate a reception log; a second monitoring apparatus configured to monitor a packet inputted to and outputted from a gateway apparatus configured to transfer user data, sort the packet for each session, identify a type of an application which generates the session, and generate a session log including the type of an application; and a traffic management server configured to acquire the reception log generated by the first monitoring apparatus and the session log generated by the second monitoring apparatus, correlate the reception log with the session log by using an occurrence time of the reception log, an occurrence time of the session log, and an identifier of the terminal, and identify an application related to a session which generated the control signal.

According to a typical aspect of the present invention, it becomes possible to identify the application which generates signaling. Problems besides those stated above, configuration, and advantages will be apparent from the following description of the embodiments.

### BRIEF DESCRIPTION OF THE DRAWINGS

The present invention can be appreciated by the description which follows in conjunction with the following figures, wherein:

FIG. 1 is a diagram illustrating a configuration of a cellular communication system according to a first embodiment of this invention;

FIG. 2 is a diagram illustrating a configuration of a packet detail analysis apparatus (CP-DPI) according to the first embodiment of this invention;

FIG. 3 is a diagram illustrating an example of a configuration of a user information management table according to the first embodiment of this invention;

FIG. 4 is a diagram illustrating an example of a configuration of a signaling record output file according to the first embodiment of this invention;

FIG. 5 is a flowchart of a user information update process according to the first embodiment of this invention;

FIG. 6 is a flowchart of a signaling record generation process according to the first embodiment of this invention;

FIG. 7 is a flowchart of a record output process according to the first embodiment of this invention;

FIG. 8 is a diagram illustrating a configuration of a packet detail analysis apparatus (UP-DPI) according to the first embodiment of this invention;

FIG. 9 is a diagram illustrating information included in a session record which is transmitted from the UP-DPI to a traffic management server according to the first embodiment of this invention;

FIG. 10 is a flowchart of a session record management process according to the first embodiment of this invention;

FIG. 11 is a diagram illustrating a configuration of the traffic management server according to the first embodiment of this invention;

FIG. 12 is a diagram illustrating an example of a configuration of a correlated record management table according to the first embodiment of this invention;

FIG. 13 is a diagram illustrating an example of a configuration of a connection application record management table according to the first embodiment of this invention;

FIG. 14 is a flowchart of a record correlation process according to the first embodiment of this invention;

FIG. 15 is a flowchart of a statistical processing according to the first embodiment of this invention;

FIGS. 16A, 16B and 16C are diagrams illustrating an example of a screen generated by a statistical output display program according to the first embodiment of this invention;

FIG. 17 is a flowchart of a record output process according to a second embodiment of this invention;

FIG. 18 is a flowchart of a record output process according to a third embodiment of this invention;

FIG. 19 is a diagram illustrating a configuration of a cellular communication system according to a fourth embodiment of this invention;

FIG. 20 is a diagram illustrating a configuration of a packet detail analysis apparatus (UP-DPI) according to the fourth embodiment of this invention;

FIG. 21 is a diagram illustrating an example of a configuration of a user information management table according to the fourth embodiment of this invention;

FIG. 22 is a diagram illustrating an example of a configuration of a session record according to the fourth embodiment of this invention;

FIG. 23 is a transition diagram illustrating a user connection status managed at the UP-DPI according to the fourth embodiment of this invention;

FIG. 24 is a flowchart of a user information update process according to the fourth embodiment of this invention;

FIG. 25 is a flowchart of a session labeling process according to the fourth embodiment of this invention;

FIG. 26 is a flowchart of a record correlation process according to the fourth embodiment of this invention; and

FIG. 27 is a flowchart of a record output process according to the fifth embodiment of this invention.

### DETAILED DESCRIPTION OF THE EMBODIMENTS

Hereinafter, embodiments of the present invention will be described in detail with reference to drawings.

Note that while the following embodiments may be described when necessary in a manner where an embodiment is split into multiple sections or embodiments for the convenience of the description, unless specifically designated as such, they will be understood to complement, modify, relate in detail, and supplement one another.

Also, in the description of the embodiments below, it is understood that the number of each element, or the like (including the number of units, numerical values, quantity, scope, and the like) shall not, unless specified otherwise or clearly necessary in principle, be limited to the specific number used in the description, and they may be greater or smaller than those stated herein.

Further, it goes without saying that in the description of the embodiments below, each constituent element (including elements steps) is not necessarily essential unless specified otherwise or clearly necessary in principle.

In the embodiments herein, LTE which is standardized in 3GPP will be used as an example of a cellular communication system to illustrate a traffic management system configured to acquire the information of an application that caused signaling.

### First Embodiment

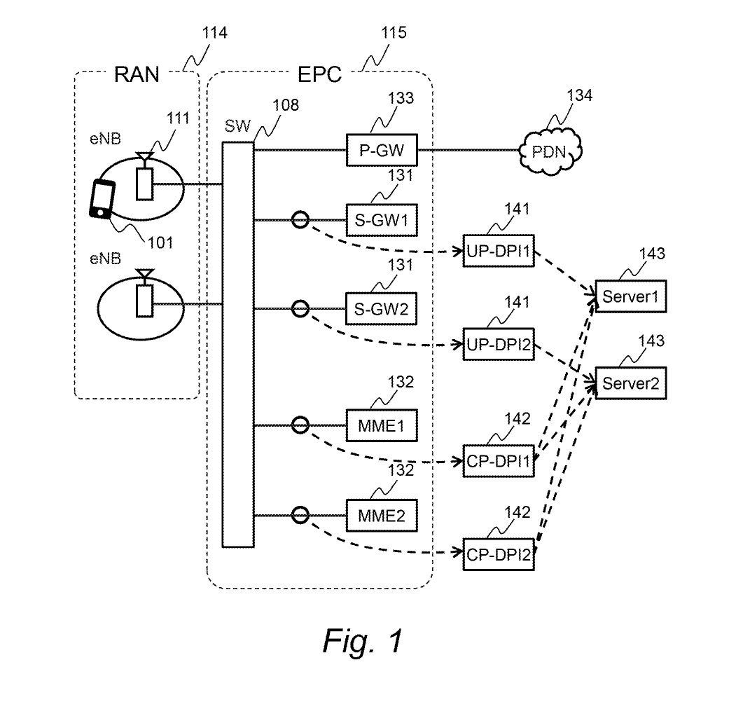

FIG. 1 illustrates a configuration of a cellular communication system according to a first embodiment.

The cellular communication system according to the first embodiment includes an eNodeB 111, which is a base station apparatus; an S-GW 131 and a P-GW 133, which are gateway apparatus; an MME 132, which is a communication control apparatus; an UP-DPI 141 and a CP-DPI 142, which are packet detail analysis apparatus; and a traffic management server 143. The eNodeB 111 will be connected with a UE 101, which is a user terminal.

The S-GW 131 includes a traffic transfer function for user plane. The MME 132 is an apparatus configured to manage mobility of the UE 101, and transmit and/or receive signaling of a control plane. The P-GW 133 includes an interface for a PDN 134 providing service for users. The S-GW 131, the MME 132, and the P-GW 133 are connected with one another to form a core network (EPC) 115.

The packet detail analysis apparatuses 141 and 142 are apparatus configured to acquire packets on the network and acquire traffic and signalings that are transmitted and received among network nodes such as the eNodeB 111, the S-GW 131, the MME 132, and the P-GW 133, and between the P-GW 133 and the PDN 134. The packet detail analysis apparatuses 141 and 142 transmit the information of the acquired traffic and signalings to the traffic management server 143. The traffic management server 143 uses the information acquired from the packet detail analysis apparatuses 141 and 142 to acquire the information of the application that was the cause of the signaling.

According to the present embodiment, the UP-DPI 141 is arranged for each S-GW so as to acquire the traffic transferred at reference points S1-U and S11. The CP-DPI 142 is arranged for each MME so as to acquire the traffic transferred at reference points S1-MME, NAS, S6a, S10, and S11. In the description hereinbelow, a case where traffic is acquired at these reference points will be described. Note, however, that one UP-DPI 141 may include multiple S-GWs 131, or multiple UP-DPIs 141 may include one S-GW 131. In a similar manner, one CP-DPI 142 may include multiple MMEs 132, or multiple CP-DPIs 142 may include one MME 131.

Also, the UP-DPI 141 and the traffic management server 143 may be accommodated in one computer. In a similar manner, the CP-DPI 142 and the traffic management server 143 may be accommodated in one computer.

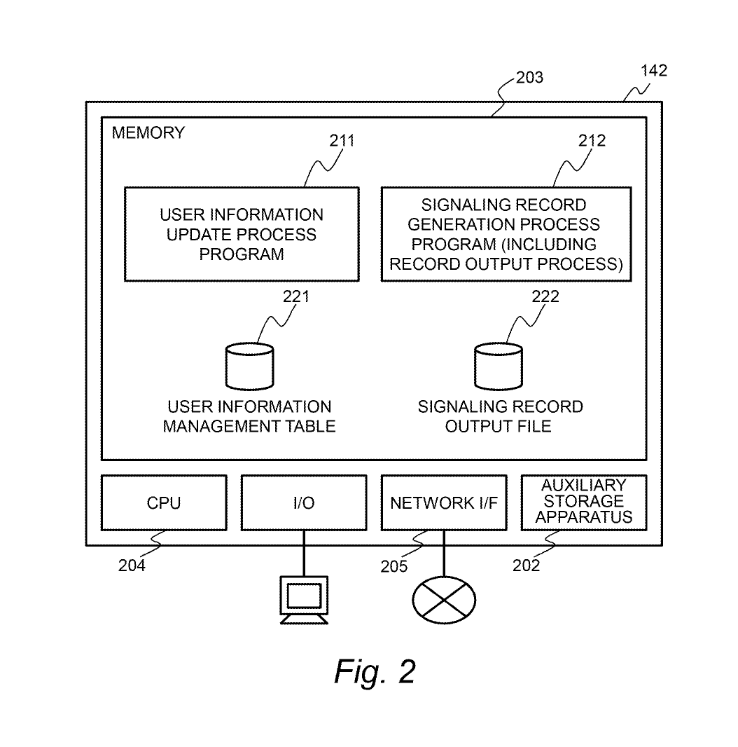

FIG. 2 illustrates a configuration of the packet detail analysis apparatus (CP-DPI) 142 according to the first embodiment.

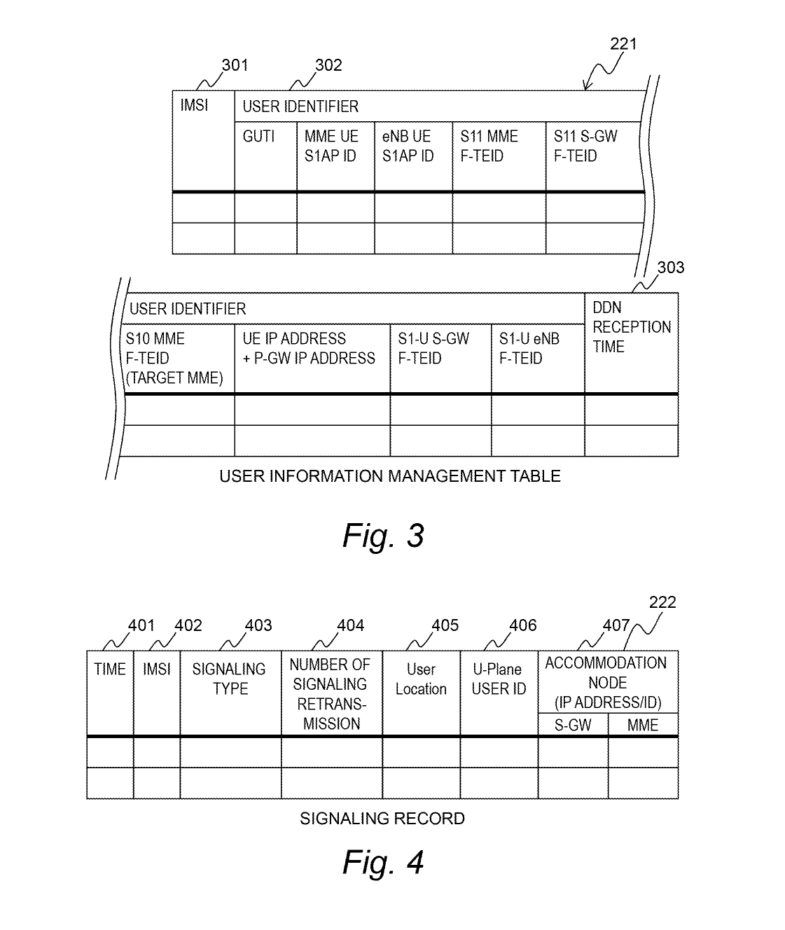

Features of the CP-DPI 142 are stored as programs (software) at an auxiliary storage apparatus 202 arranged for general computers, and executed as a CPU 204 expands the program read out from the auxiliary storage apparatus 202 on the memory. The CP-DPI 142 acquires via a network I/F 205 the traffic transferred at each reference point so as to communicate with the traffic management server 143. The memory 203 of the CP-DPI 142 stores therein a user information update process program 211 and a signaling record generation process program 212. Further, the memory 203 of the CP-DPI 142 stores therein a user information management table 221 (See FIG. 3) and a signaling record output file 222 (See FIG. 4).

The program executed by the CPU 204 is provided to the CP-DPI 1142 via a removable media (CD-ROM, flash memory, or the like) or a network, and stored at the auxiliary storage apparatus 202, which includes a non-transitory storage medium. Accordingly, the CP-DPI 142 preferably includes an interface configured to read data from removable media.

The CP-DPI 142 is a computer system which includes one physical computer or a plurality of computers configured in a logical or physical manner, where the above stated program may operate under separate threads at the same computer, or operate at a virtual computer configured on multiple physical computer resources.

The outline of the characteristic of the CP-DPI 142 according to the first embodiment may be briefly described as the following. That is, the CP-DPI 142 acquires the signaling traffic that is inputted to or outputted from the MME 132, extracts a signaling requesting connection with the network, and identified the UE 101 that is related to the signaling. Then, the CP-DPI 142 generates a signaling record, which is a reception log including the UE 101 that is requesting connection and the signaling type, and transmits the generated signaling record to the traffic management server 143.

FIG. 3 illustrates an example of a configuration of the user information management table 221 according to the first embodiment.

For each UE 101, the user information management table 221 stores therein a user for identifying the UE 101 at the network device or each reference point the UE 101 is stored. To be more specific, the user information management table 221 includes an IMSI for uniquely identifying each UE 101, a user identifier 302 for identifying the UE 101 at each reference point, and a DDN reception time 303. The user identifier 302 includes a GUTI, an MME UE S1AP ID, an eNB UE S1AP ID, an S11 MME F-TEID, an S11 S-GW F-TEID, an S10 MME F-TEID, an UE IP Address+P-GW IP Address, an S1-U SGW F-TEID, and an S1-U eNB F-TEID, or the like. The F-TEID includes a TEID which is an identifier of an IP address and a tunnel. The DDN reception time 303 stores therein the reception time when the signaling “Downlink Date Notification (DDN)” transferred at the S11 with respect to the UE.

FIG. 4 illustrates an example of a configuration of the signaling record output file 222 according to the first embodiment.

The signaling record output file 222 stores therein information included in the signaling record that is transmitted to the traffic management server 143 from the CP-DPI 142. To be more specific, the signaling record output file 222 includes a time 401, an IMSI 402, a signaling type 403, a number of signaling retransmission 404, a User Location 405, a U-Plane User ID 406, and an accommodation node (an IP Address of or an ID for uniquely identifying the S-GW or MME).

The signaling record output file 222 records the reception log of the signalings related to connection request to the network by the UE 101. The time 401 stores therein signaling reception time. The signaling type 403 stores therein an SRMO (Service Request-Mobile Originated), SRMT (Service Request-Mobile Terminated), an ESRMO-PS (Extended Service Request-Mobile Originated, Non-CSFB), or the like, for example. The User Location 405 stores therein the location of the UE at the time of transmitting the signaling such as ECGI, an eNB ID, or the like, for example. The U-Plane user ID 406 stores therein an UE IP Address (PDN Allocation)+P-GW IP Address, or an S1-U F-TEID (S-GW or eNB). The accommodation node 407 stores therein an IP Address of the S-GW or the MME configured to store the UE, or an ID configured to uniquely identify the S-GW or the MME.

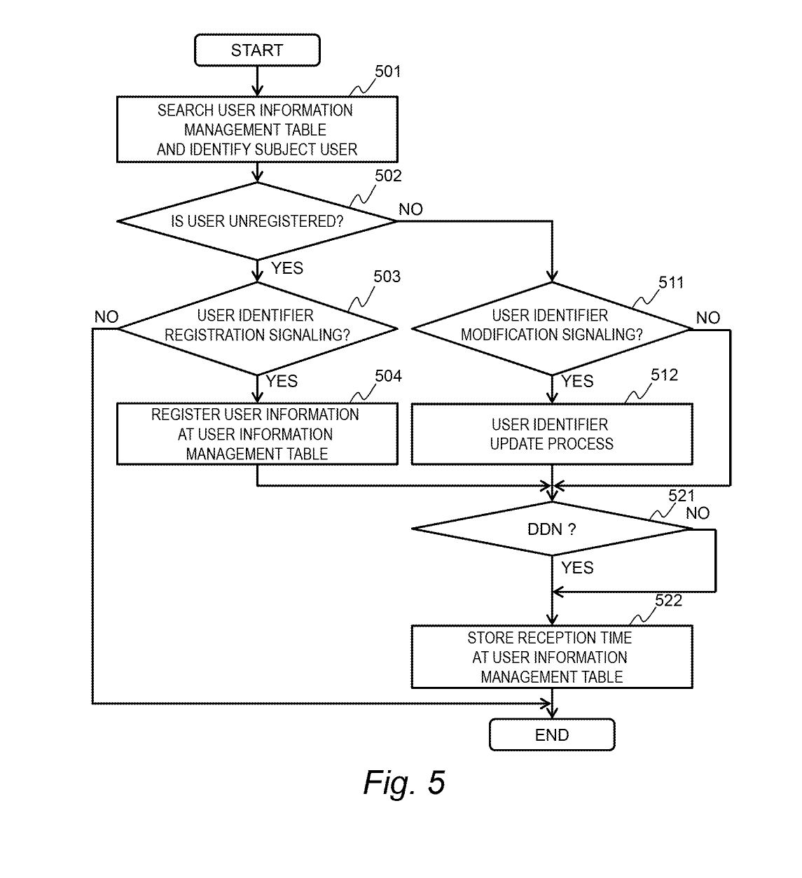

FIG. 5 is a flowchart of a user information update process according to the first embodiment. The user information update process illustrated in FIG. 5 is executed as the CPU 204 of the CP-DPI 142 executes the user information update process program 211.

The user information update process program 211, which is executed when a signaling is received, registers and updates the user identifier 302 stored at the user information management table 221, and registers the DDN reception time 303 at DDN reception time.

Firstly, the CPU 204 of the CP-DPI 142 refers to the user information management table 221 so as to search the UE 101 which is a subject related to the received signaling (Step 501), and determine whether the subject UE 101 was identified (Step 502).

In a case where the UE 101 is not registered at the user information management table 221, it will be determined that the UE 101 is identifiable, and the determination is made as to whether the user identifier will be registered using the signaling (Step 503). In a case where the user identifier will be registered, the IMSI and the user identifier are registered at the user information management table 221 (Step 504) to execute the following process (Step 521). At Step 503, in a case where the user identifier is not registered using the signaling, the process ends.

At Step 502, in a case where the information of the UE 101 is registered at the user information management table 221, it will be determined that the UE 101 is identifiable, and the determination is made as to whether the user identifier will be updated using the signaling (Step 511). In a case where the user identifier will be updated, the information at the user information management table 221 is updated (Step 512) to execute the following process (Step 521).

Then, an update process for the DDN reception time will be executed. That is, at Step 521, the determination will be made as to whether or not the signaling includes the DDN. Then, in a case where the signaling includes the DDN, the reception time is stored at the user information management table 221 (Step 522) to end the process. On the other hand, in a case where the signaling does not include the DDN, the process ends.

Note that the signaling related to registering or updating the user information refers to the signaling, such as ATTACH, or Create Session Request, or the like, for updating the correspondence among each identifier stored at the user information management table 221.

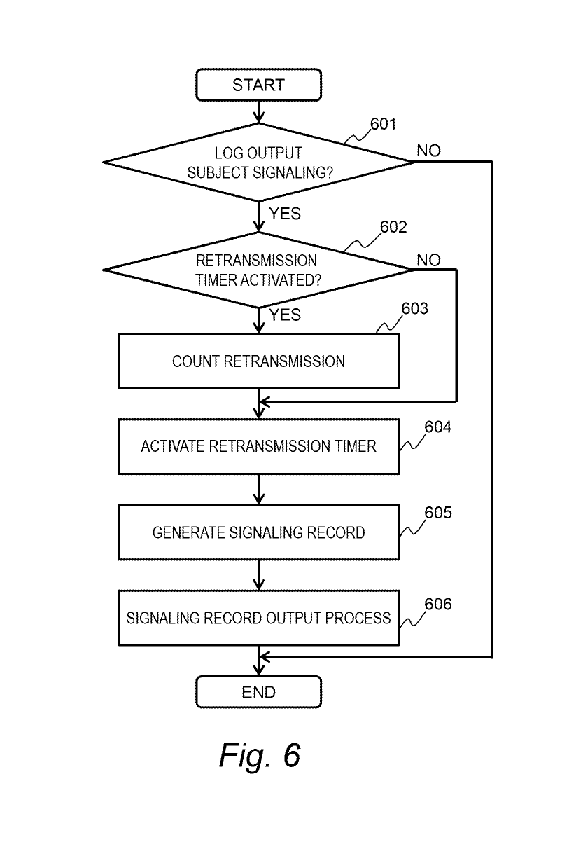

FIG. 6 is a flowchart of a signaling record generation process according to the first embodiment. The signaling record generation process illustrated in FIG. 6 is executed as the CPU 204 of the CP-DPI 142 executes the signaling record generation process program 212.

The signaling record generation process program 212, which is executed after the user information update process program 211 is executed, generates the signaling record which is a reception of the signaling.

Firstly, the CPU 204 of the CP-DPI 142 makes a determination as to whether the signaling includes the signaling that is the subject for log output (Step 601). In a case where the signaling does not include the log output subject, the process ends. Meanwhile, in a case where the signaling includes the log output, that is, SR (Service Request) or ESR (Extended Service Request), or the like, has been received, a retransmission count process in Step 602, Step 603, Step 604, a signaling record generation process in Step 605, and a signaling record output process in Step 606 will be conducted subsequently.

To be more specific, a determination will be made as to whether a retransmission time is activated in Step 602. The retransmission timer used in Step 602 includes the timer that is activated (activated in the previous Step 604) when the signaling that is the same as the UE 101 is received. In a case where the retransmission timer is activated (Step 602), the retransmission counter will be counted up (Step 603).

Then, the retransmission timer is activated in Step 604, information is acquired from the user information management table 221, or the like, in Step 605 so as to generate the signaling record. In generating the signaling records, the signaling type is specified. For example, in a case where an SR signaling is received, the DDN reception time 303 of the user information management table 221 is referenced, and in a case where the DDN is generated within a predetermined period of time it will be determined that the signaling type include the SRMT. On the other hand, in a case where the DDN is not generated within a predetermined period of time, it will be determined that the signaling type includes the SRMO.

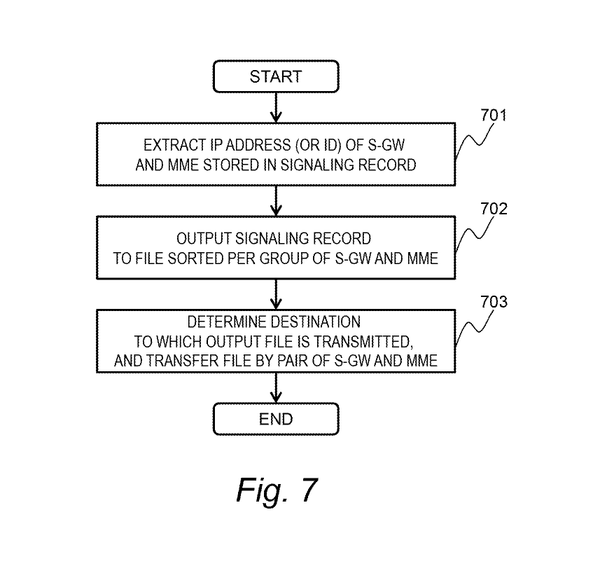

Finally, in Step 606, the signaling record output process is executed to end the process. The details of the signaling record output process will be described will be described below with reference to FIG. 7.

FIG. 7 is a flowchart of the record output process according to the first embodiment. The record output process illustrated in FIG. 7 is executed as the CPU 204 of the CP-DPI 142 or the UP-DPI 141 executes the signaling record generation process program 212 when the CP-DPI 142 outputs the signaling record, or when the UP-DPI 141 outputs the session record.

The signaling record is sorted in separate files for each pair of the S-GW 131 and the MME 132 accommodating therein the UE 101, managed and outputted.

To be more specific, firstly, the CPU 204 of the CP-DPI 142 extracts the IP Address (or ID of each) of the S-GW and MME indicated in the signaling record (Step 701), determines a file to which the signaling record is outputted for each pair of the extracted S-GW and MME, and outputs the signaling record to the file (Step 702). Then, the CPU 204 of the CP-DPI 142 determines the traffic management server 143 which processes the signaling record file created for each pair of the S-GW and the MME as a key to the pair of the S-GW and the MME, and transfers the signaling record file to the determined the traffic management server 143 (Step 703).

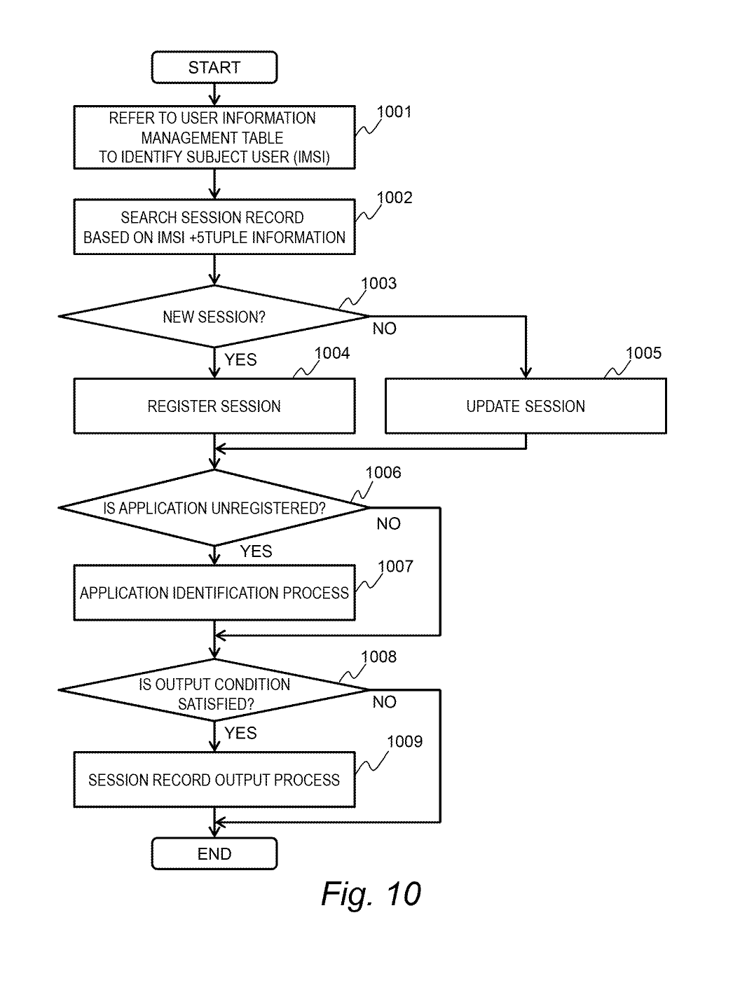

The record output process can also be called from a session record management process program 811 (1009 in FIG. 10) to output the session record of the UP-DPI 141. In such case, the “signaling record” in the flowchart should be replaced with the “session record.”

The session record is sorted in separate files for each pair of the S-GW 131 and the MME 132 accommodating therein the UE 101, managed and outputted.

To be more specific, firstly, the CPU 204 of the UP-DPI 141 extracts the IP Address (or ID of each) of the S-GW and the MME stored in the session record (Step 701), determines a file to which the session record is outputted for each pair of the extracted S-GW and MME, and outputs the session record to the file (Step 702). Then, the CPU 204 of the UP-DPI 141 determines the traffic management server 143 which processes the session record file created for each pair of the S-GW and the MME as a key to the pair of the S-GW and the MME, and transfers the session record file to the determined the traffic management server 143 (Step 703).

Note that it is preferable to execute the file transfer process of Step 703 in a periodical manner, or in a predetermined interval of time when a predetermined number of records have been accumulated and when other conditions have been satisfied. Also, the packet detail analysis apparatuses 141 and 142 may be configured to store therein only the file while the traffic management server 143 may be configured to transfer the files.

Note that while an example in which the signaling records and the session records are sorted in separate files for each pair of the S-GW 131 and the MME 132 is described, the signaling records and the session records may be outputted in a format different from that which is described above so long as the UP-DPI 141 and the CP-DPI 142 process the signaling records and the session records in a manner sorted by the pairs of the S-GW 131 and the MME 132.

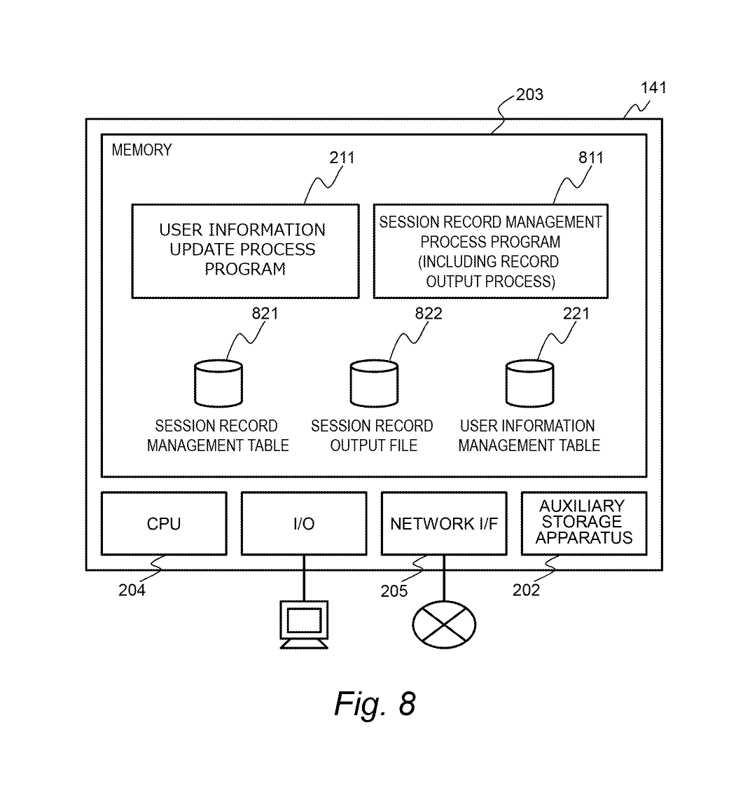

FIG. 8 illustrates a configuration of the packet detail analysis apparatus (UP-DPI) 141 according to the first embodiment.

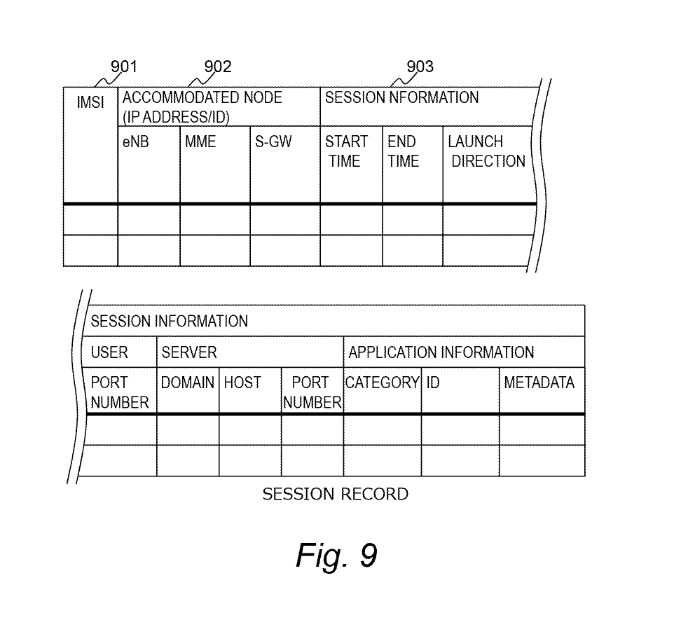

Features of the UP-DPI 141 are stored as programs (software) at the auxiliary storage apparatus 202 arranged for general computers, and executed as the CPU 204 expands the program read out from the auxiliary storage apparatus 202 on the memory. The UP-DPI 141 acquires via the network I/F 205 the traffic transferred at each reference point so as to communicate with the traffic management server 143. The memory 203 of the UP-DPI 141 stores therein the user information update process program 211 and the session record management process program 811. Further, the memory 203 of the UP-DPI 141 stores therein the user information management table 221 (See FIG. 3), a session record management table 821 (See FIG. 9), and a session record output file 822 (See FIG. 9).

The program executed by the CPU 204 is provided to the UP-DPI 141 via a removable media (CD-ROM, flash memory, or the like) or a network, and stored at the auxiliary storage apparatus 202, which includes a non-transitory storage medium. Accordingly, the UP-DPI 141 preferably includes an interface configured to read data from the removable media.

The UP-DPI 141 is a computer system which includes one physical computer or a plurality of computers configured in a logical or physical manner, where the above stated program may operate under separate threads at the same computer, or operate at a virtual computer configured on multiple physical computer resources.

The outline of the characteristic of the UP-DPI 141 according to the first embodiment may be briefly described as the following. That is, the UP-DPI 141 acquires the user traffic that is transferred at the S1-U, classifies the user traffic per UE 101 and per session, identifies an application for each session, generates a session record which includes the information of the session and the information of the node in which the UE 101 is accommodated, and transmits the generated session record to the traffic management server 143. Note that the user information update process program 211 and the user information management table 221 are the same as those implemented at the CP-DPI. Note, however, that the UP-DPI, which includes S1-U and S11 as reference points, includes a configuration where the information related to GUTI, S1AP, or S10 are excluded.

FIG. 9 illustrates the information included in the session record which is transmitted from the UP-DPI 142 to the traffic management server 143 according to the first embodiment. That is, FIG. 9 illustrates the information included in the session record management table 821 and the session record output file 822.

The session record management table 821 is a table, which retains the information related to an ongoing session, in which search is conducted and is updated when the user traffic arrives. The session record output file 822 retains the information related to a session that ended or a session which has identified an application.

The session record includes an IMSI 901, information 902 of an accommodation node which accommodates therein the UE 101, and information 903 of the session in which the UE 101 communicated. The information 902 of the accommodation node stores therein the IP Address or the ID of an eNB, an MME, and an S-GW. The session information 903 includes the information related to the start time, end time, communication launch direction of a session. The communication launch direction makes a determination as to whether the source of a transmission of a packet is the UE or the server based on the packet received first in a session, and records the transmission source. Also, the session information 903 includes the port number of the UE, the IP Address, a host name or a domain name of the server, and the port number of the server so as to identify each session. Further, the session information 903 includes the information related to the application of the session (application ID, category, metadata). Additionally, the session information 903 may also include the information concerning the number of packets transferred or the number of bytes.

FIG. 10 is a flowchart of the session record management process according to the first embodiment. The session record management process illustrated in FIG. 10 is executed as the CPU 204 of the UP-DPI 141 executes the session record management process program 811.

The session record management process program 811, which is executed when a user packet is received at the S1-U, is a program configured to register and update the session information of the session record management table 821, and output the updated information to the to the session record output file 822 when the session ends.

Firstly, the CPU 204 of the UP-DPI 141 refers to the user information management table 221 so as to identify a subject user (IMSI) related to the user packet received (Step 1001), identify the session based on the IMSI and a 5tuple (transmission source IP Address, destination IP Address, transmission source port number, destination port number, protocol number) included in the user packet of the S1-U, and search the session record management table 821 by using the information of the identified session (Step 1002). Then, the CPU 204 of the UP-DPI 141 makes a determination as to whether or not the session includes a new session depending on whether the information related to the session is included in the session record management table 821 (Step 1003).

In a case where the information of the session is not retrieved, it is determined that the session did not include a new session, and the session is registered as new (Step 1004). A process to register a new session includes storing the session information at the session record management table 821. To be more specific, accommodation node information is acquired from the session record management table 821, and the user information, server information, launch direction of the session information of the received user packet are acquired, and the acquired information will be stored. Also, packet acquisition time is stored at the start time.

On the other hand, in a case where the information of the session is retrieved in Step 1003, it is determined that the session includes a new session, and the information of the session is updated (Step 1004). A process to update the information of the session includes updating the end time, and adding the number of packets transferred and the number of bytes, or the like. To be more specific, a determination will be made as to whether the application is already identified based on whether the application information is stored at the session record management table 821 (Step 1006). Then, in a case where the session record management table 821 does not include the application information stored therein, it will be determined that the application is not yet identified, and an identification process of the application will be carried out by using the user packet (Step 1007). On the other hand, in a case where the session record management table 821 includes the application information stored therein and the application is identified in Step 1006, the identification result is stored at the application information of the session record. Note that the application identification process in Step 1007 may be carried out by an application identification program that is configured exclusively for such purpose.

Finally, a process to output the session record is carried out in Steps 1008 and 1009. An output condition in Step 1008 includes, for example, that an application has already been identified, that a session end message, such as a FIN packet, or the like, has already been received, or the like. Also, the session record output process of Step 1009 includes the record output process which was explained with reference to FIG. 7.

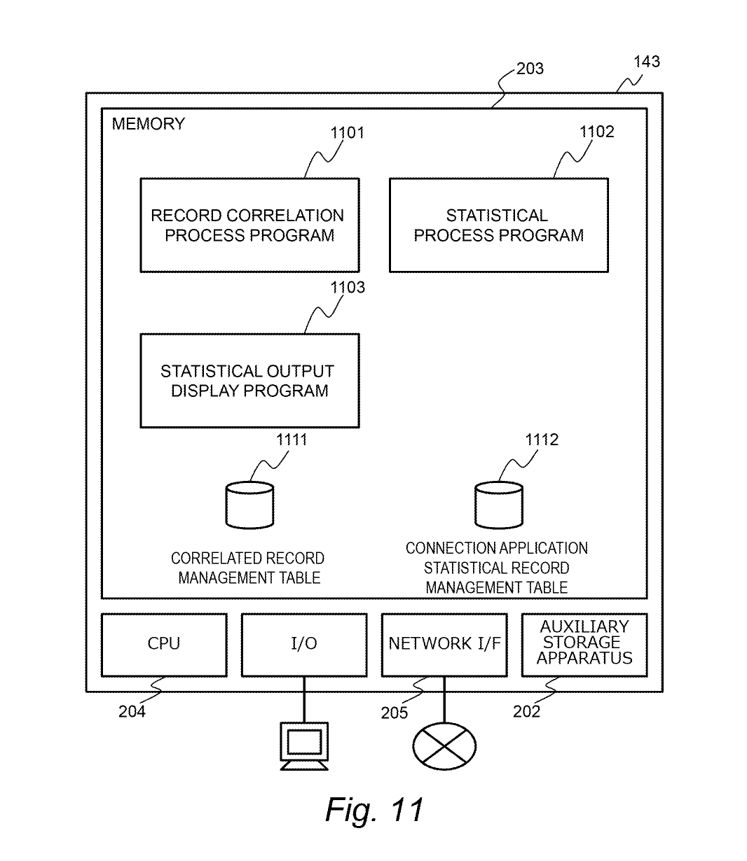

FIG. 11 illustrates a configuration of the traffic management server 143 according to the first embodiment.

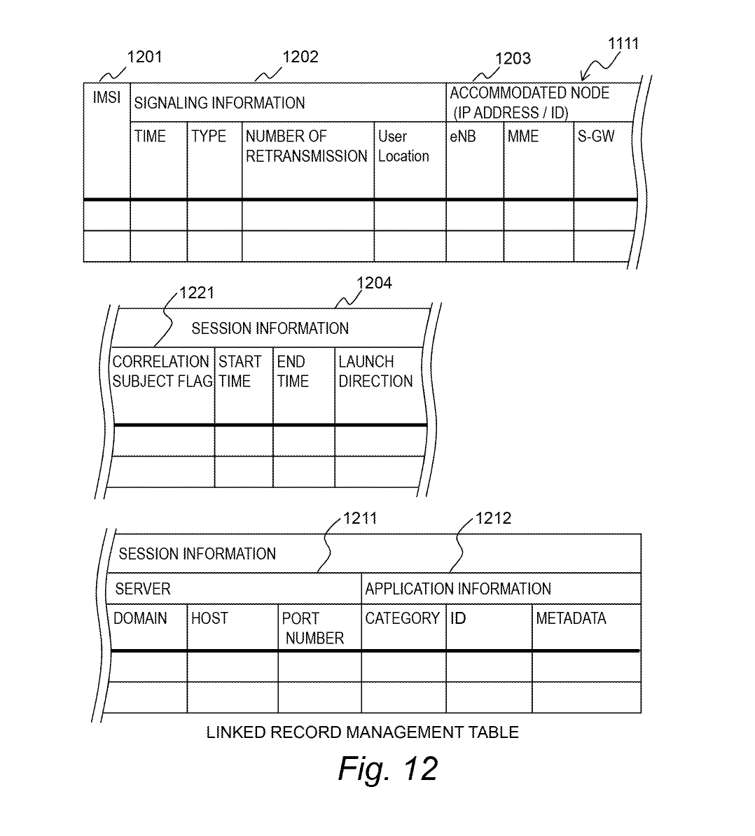

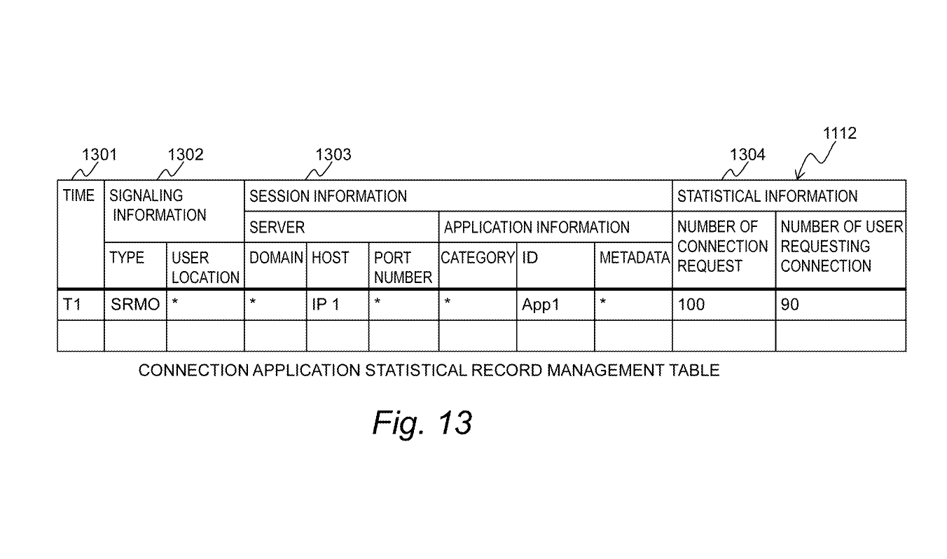

Features of the traffic management server 143 are stored as programs (software) at the auxiliary storage apparatus 202 arranged for general computers, and executed as the CPU 204 expands the program read out from the auxiliary storage apparatus 202 on the memory. The traffic management server 143 communicates via the network I/F 205 with the CP-DPI 142 and the UP-DPI 141. The memory 203 of the traffic management server 143 stores therein a record correlation process program 1101, a statistical process program 1102, and a statistical output display program 1103. Further, the memory 203 of the traffic management server 143 stores therein a correlated record management table 1111 (See FIG. 12) and a connection application statistical record management table 1112 (See FIG. 13).

The program executed by the CPU 204 is provided to the traffic management server 143 via a removable media (CD-ROM, flash memory, or the like) or a network, and stored at the auxiliary storage apparatus 202, which includes a non-transitory storage medium. Accordingly, the traffic management server 143 preferably includes an interface configured to read data from the removable media.

The traffic management server 143 is a computer system which includes one physical computer or a plurality of computers configured in a logical or physical manner, where the above stated program may operate under separate threads at the same computer, or operate at a virtual computer configured on multiple physical computer resources.

The outline of the characteristic of the traffic management server 143 according to the first embodiment may be briefly described as the following. That is, the traffic management server 143 acquires the signaling record from the CP-DPI 142, acquires the session record from the UP-DPI 141, and correlates the signaling record and the session record with one another in a statistical manner, so as to visualize the information of the application that caused the signaling.

FIG. 12 illustrates an example of a configuration of the correlated record management table 1111 according to the first embodiment.

The correlated record management table 1111 includes a table configured to use the IMSI and time information so as to merge the signaling record and the session record. To be more specific, the correlated record management table 1111 includes a table configured to store the information of the signaling record at signaling information 1202, and store the information of the session record at an accommodation node 1203 and session information 1204. The session information 1204 sets up a new correlation subject flag 1221 to store the information which indicates whether or not there is any signaling that is correlated to the session. Also, the session information 1204 includes information 1211 of a server that accommodates therein the session and information 1212 of an application that is related to the session.

FIG. 13 illustrates an example of a configuration of the connection application record management table 1112 according to the first embodiment. The connection application record management table 1112 includes a table configured to store therein a result of a statistical processing conducted to a correlated record. According to the present embodiment, an example in which items from the correlated record that are aggregated statistically including a type and a User Location from signaling information 1302, a domain, a host, and a port number from server information of session information 1303, a category, an ID, metadata from application information of the session information 1303 stored in a correlated manner will be described. Then, the statistical information of a record in which all of the statistical aggregated items match will be stored at statistical information 1304. Note that the statistical aggregated items may include “*” which indicates data that is “optional.” For example, in a predetermined time t (T1≦t<T1+α) in an entry in the first row, it is indicated that there are 100 connection requests (SRMO) issued from an UE that are estimated to be transmitted so as to be connected with a server host IP 1 by an application App 1, and that there are 90 unique UEs 101 requesting connection. Here, a refers to a time period for aggregating the statistics.

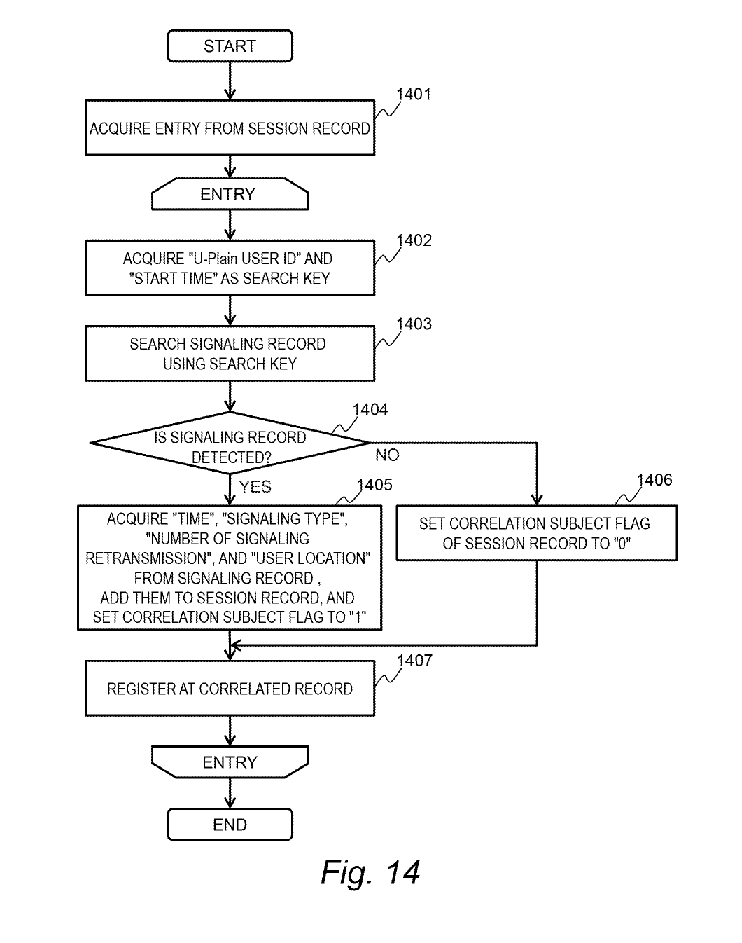

FIG. 14 is a flowchart of a record correlation process according to the first embodiment. The record correlation process illustrated in FIG. 14 is executed as the CPU 204 of the traffic management server 143 executes the record correlation process program 1101.

The record correlation process program 1101 is executed when the signaling record is received from the CP-DPI 141, or when the session record is received from the UP-DPI 142. Since the signaling record and the session record are filed for each pair of the S-GW and the MME, a record file for each pair of the S-GW and the MME is acquired, and a correlation process is executed thereto.

To be more specific, firstly, the CPU 204 of the traffic management server 143 acquires an entry from the session record, and the processes of Step 1402 through Step 1407 are executed in a repeated manner with respect to each entry (Step 1401).

Within a loop, the IMSI and the session start time of the entry are acquired as search key (Step 1402), and a signaling record will be retrieved by using the search key (Step 1403). The search field for the session start time includes “time” of the signaling record, wherein the signaling record will be retrieved from a period of time which includes a predetermined amount of time before and after the session start time. In a case where the signaling record is detected from this retrieval (Step 1404), relevant information is registered at the correlated record management table 1111 (Step 1407), in which “time,” “signaling type,” “number of signaling retransmission,” and “User Location” of the information of the signaling record are merged with the corresponding entries of the session record, and the correlation subject flag 1221 is set as “1” (Step 1405).

On the other hand, in a case where the signaling record is not detected in Step 1404, the correlation subject flag 1221 is set as “0,” and registered at the correlated record management table 1111 while the information for signaling record remains blank (Step 1407).

Then, the process ends after the process is executed with respect to all the entries of the session records.

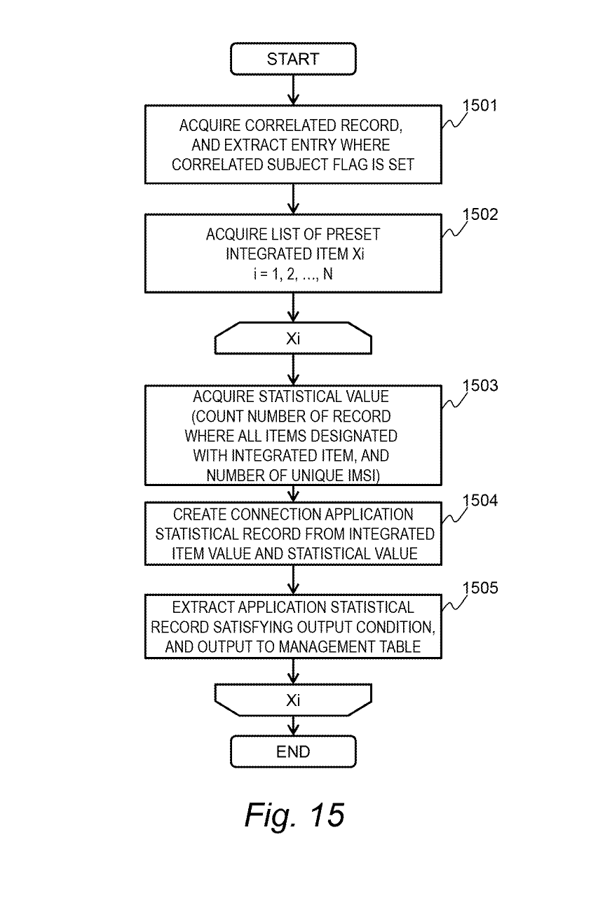

FIG. 15 is a flowchart of the statistical processing according to the first embodiment. The statistical processing illustrated in FIG. 15 is executed as the CPU 204 of the traffic management server 143 executes the statistical process program 1102.

The statistical process program 1102 converts the information of the application, in which the correlated record is inputted, which is executed at a fixed interval, and generated a signaling in a statistical manner. A period for statistical aggregation may be set in an arbitrary manner by an operator. Note that all of the signaling records and the session records that are generated within the statistical aggregation period and are correlated with one another in a corresponding manner will be referred to as correlated records which will be inputted. Note that the statistical processing sets up a list of items to be aggregated and the output condition prior to the execution of the process. The list of items to be aggregated includes a list of aggregated items where an arbitrary field is selected from the fields included in the connection application record management table 1112. An example of this includes an aggregated item X1 (time, signaling type, domain, and host), and an aggregated item X2 (time, signaling type, host, and application ID), or the like. The output condition includes a condition which is outputted to the connection application record management table 1112. An example of this includes a condition such as a statistical value being greater than a certain value, or a field of an aggregated item including a specific value, or the like.

To be more specific, firstly, the CPU 204 of the traffic management server 143 acquires the correlated record, and extracts an entry whose 1221 is set as “1” (Step 1501). Next, the CPU 204 of the traffic management server 143 acquires an aggregated item Xi which is set in advance (Step 1502). Note that i includes an integer between 1 and N. The following processes will be executed for each aggregated item Xi. Then, the CPU 204 of the traffic management server 143 acquires a statistical value. Here, the number of records whose items match with all of the items designated by the aggregated item and the number of unique IMSI are counted (Step 1503). In Step 1504, the CPU 204 of the traffic management server 143 creates a connection application statistical record from the value of the items designated by the aggregated item and the statistical value acquired in Step 1503 (Step 1504). Then, the CPU 204 of the traffic management server 143 extracts out of the connection application statistical record created in Step 1504 one that satisfies the output condition, and outputs the same to the connection application record management table 1112 (Step 1505).

Then, the process ends after the process is executed with respect to all of the aggregated items.

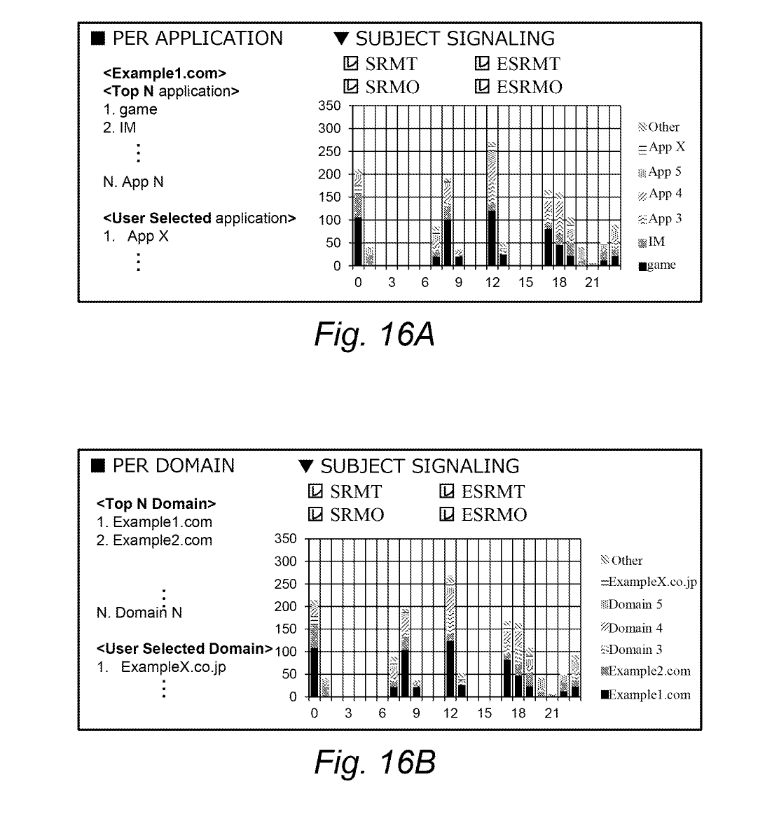

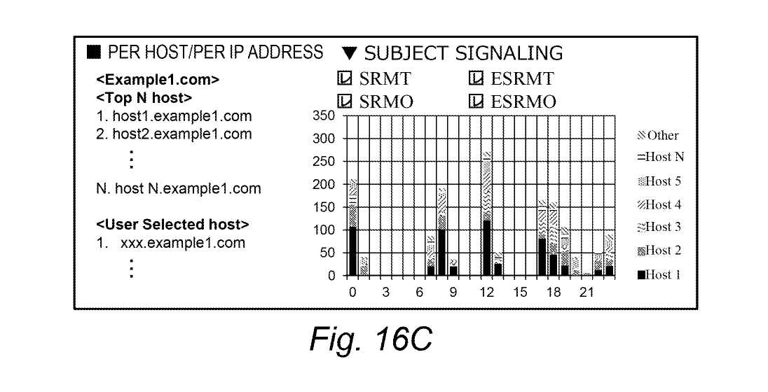

FIGS. 16A, 16B and 16C illustrate an example of a screen generated by the statistical output display program 1103 according to the first embodiment.

The statistical output display program 1103, which is executed in accordance with a display request from an operator, acquires the information retained at the connection application record management table 1112, and outputs the statistical information 1304 of the connection application record management table 1112 to a screen configured to display graphs. FIGS. 16A, 16B and 16C illustrate an example of a screen that is displayed per application, per domain, and per host/IP address, respectively.

For example, according to the display screen per application illustrated in FIG. 16A configured to display statistical information which aggregates items including time, signaling type, and application ID, whereas the display screen per domain displays the statistical information which aggregates the aggregated items (time, signaling type, and domain). The statistical output display program 1103 displays a cumulative graph showing statistical values including N number of signalings from the top of the list of signalings that are generated most frequently out of the signalings that are selected for display, and an item specified by an operator. Note that in order to visualize the information, specific field values of the connection application record management table 1112 may be designated so as to display the signalings that are ranked high under such condition. Also, the output screen may designate a specific time to display the information in a pie graph. Also, the information may be displayed in a text format as well. In a case where working with multiple traffic management servers, the information of the connection application record management table 1112 that is connected with each traffic management server may be merged for display as well.

In the description above, a configuration in which the above stated programs and information are stored at the memory 203 of one computer for the CP-DPI 142, the UP-DPI 141, and the traffic management server 143 has been described. However, such information may be stored at the auxiliary storage apparatus 202, wherein the information is read from the auxiliary storage apparatus 202 depending on the convenience of the process executed by the programs and stored back at the auxiliary storage apparatus 202 when each process is completed.

Alternatively, the above stated programs and the above stated information may be stored in a dispersed manner. For example, the above stated information may be stored at a database different from the traffic management server 143 by implementing each piece of the information as a relational database table, where the above stated program that is executed at the traffic management server makes reference or updates the above stated information of the database server.

Also, the above stated information may be stored at a KVS (Key-Value Store) server of a distributed type that is different from the traffic management server 143, where the above stated program that is executed at the traffic management server 143 makes reference or updates the above stated information of the KVS server.

It is to be noted that the difference in the method of storing information as mentioned above shall have no effect on the substance of the present invention.

As described above, according to the first embodiment of the present invention, it becomes possible to identify and display an application that generates a signaling in a statistical manner so as to present an operator with the information such as applications, hosts, and domains that frequently generate signalings. Also, it becomes possible to adjust to the increase in the number of the UP-DPI 141 and the CP-DPI 142 that accompanies the expansion of the network in a flexible manner.

### Second Embodiment

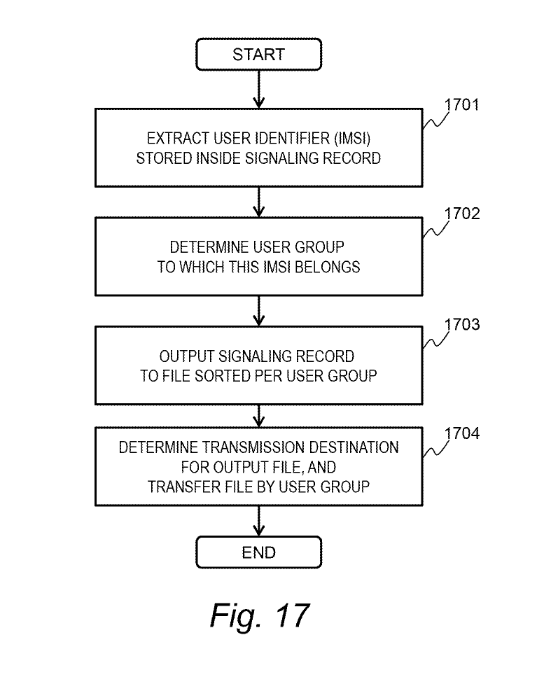

A second embodiment of the present invention will be described with reference to FIG. 17. The second embodiment is different from the first embodiment in that the UP-DPI 141 and the CP-DPI 142 execute the record output process differently. That is, according to the first embodiment, files are generated for each pair of the S-GW and the MME, where the traffic management server 143 correlates records by using the files sorted per pairs of the S-GW and the MME. However, this could be problematic when the throughput of the S-GW and that of the MME increase and the number of the signaling records and that of the session records increase, the load of the search process on the traffic management server 143 to correlate the records increases. According to the second embodiment, the process will be divided into more details so as to reduce the load of the search process by the traffic management server 143 and increase the volume of parallel processing.

FIG. 17 is a flowchart of the record output process according to the second embodiment. The record output process illustrated in FIG. 17 is executed as the CPU 204 of the CP-DPI 142 or the UP-DPI 141 executes the signaling record generation process program 212 when the CP-DPI 142 outputs the signaling record and when the UP-DPI 141 outputs the session record.

According to the second embodiment, the signaling record is sorted and managed in a file for each user group, and outputted accordingly. The user group may be generated by grouping by using the value of the last digit of the IMSI, or by applying mapping function to the IMSI, for example.

To be more specific, firstly, the CPU 204 of the CP-DPI 142 extracts the user identifier (IMSI) indicated in the signaling record (Step 1701), and determines the user group to which the extracted IMSI belongs (Step 1702). Then, the CPU 204 of the CP-DPI 142 determines a file to which the signaling record is outputted for each user group, and outputs the signaling record to the file (Step 1703). Finally, the CPU 204 of the CP-DPI 142 determines the traffic management server 143 which processes the user group, and transfers the signaling record created for each user group to the traffic management server 143 (Step 1704).

The record output process can also be called from the session record management process program 811 (Step 1009 in FIG. 10) to output the session record of the UP-DPI 141. In such case, the “signaling record” in the flowchart should be replaced with the “session record.”

The session record is sorted in separate files for each pair of the S-GW 131 and the MME 132 accommodating therein the UE 101, managed and outputted.

To be more specific, firstly, the CPU 204 of the UP-DPI 141 extracts the IMSI stored in the session record (Step 1701), determines the user group to which the extracted IMSI belongs (Step 1702). Then, the CPU 204 of the UP-DPI 141 determines the file to which the session record is outputted for each user group, and outputs the session record to the file (Step 1703). Finally, the CPU 204 of the UP-DPI 141 determines the traffic management server 143 which processes the user group, and transfers the session record file created for each user group (Step 1704).

Note that it is preferable to execute the file transfer process of Step 1704 in a periodical manner, or in a predetermined interval of time when a predetermined number of records have been accumulated and when other conditions have been satisfied. Also, the packet detail analysis apparatuses 141 and 142 may be configured to store therein only the file while the traffic management server 143 may be configured to transfer the files.

While an example in which the signaling records and the session records are sorted and outputted to separate files for each user group is described for the second embodiment, the signaling records and the session records may be outputted in a format different from that which is described above so long as the UP-DPI 141 processes the signaling records and the session records in a manner sorted by the user groups.

As described above, according to the second embodiment of the present invention, as the process is divided into more details, it becomes possible to reduce the load of the search process by the traffic management server 143 and increase the number of parallel processing. Also, the second embodiment of the present invention enables the processing load of the DPIs 141 and 142 to be equalized. In particular, in a case where the load on the S-GW 131 and the MME 132 are biased, or neither the S-GW 131 nor the MME 132 is connected in full mesh, the processing load on the DPIs 141 and 142 are equalized.

### Third Embodiment

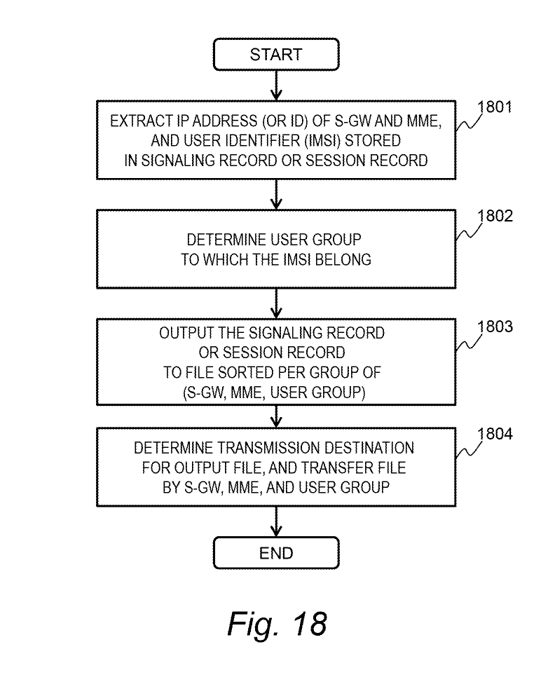

A third embodiment of the present invention will be described with reference to FIG. 18. The third embodiment is different from the first or the second embodiment in that the record output process of the UP-DPI 141 and the CP-DPI 142 according to the third embodiment is different from those in the first or the second embodiment. Note that for the description of the third embodiment only the difference between the third embodiment and the above described first and second embodiments will be described, where the same reference numerals as those used for the first and second embodiments will be used denote the same configuration and process while the description thereof will be omitted. According to the third embodiment, the file dividing method described in the first and second embodiments will be combined so that processing units will be further detailed, whereby the load of the search process by the traffic management server 143 will be reduced and the number of parallel processing will be increased.

FIG. 18 is a flowchart of the record output process according to the third embodiment. The record output process illustrated in FIG. 18 is executed as the CPU 204 of the CP-DPI 142 or the UP-DPI 141 executes the signaling record generation process program 212 when the CP-DPI 142 outputs the signaling record and when the UP-DPI 141 outputs the session record.

According to the second embodiment, the signaling record is sorted and managed in a file for each pair of the S-GW 131 and the MME 132 that is further sorted for each user group, and outputted accordingly. The user group may be generated in the method described in the second embodiment.

To be more specific, firstly, the CPU 204 of the CP-DPI 142 extracts the IP Address (or the ID) of the S-GW 131 and the MME 132, or the user identifier (IMSI) indicated in the signaling record (Step 1801), and determines the user group to which the extracted IMSI belongs (Step 1802). Then, the CPU 204 of the CP-DPI 142 determines a file to which the signaling record is outputted for each group of the S-GW 131, the MME 132, and the user group, and outputs the signaling record to the file (Step 1803). Finally, the CPU 204 of the CP-DPI 142 determines the traffic management server 143 which processes the signaling record file created for each group of the S-GW 131, the MME 132, and the user group, and transfers the signaling record created for each group of the S-GW 131, the MME 132, and the user group to the traffic management server 143 (Step 1804).

The record output process can also be called from the session record management process program 811 (Step 1009 in FIG. 10) to output the session record of the UP-DPI 141. In such case, the “signaling record” in the flowchart should be replaced with the “session record.”

The session record is sorted in separate files for each group of the S-GW 131, the MME 132, and the user group, managed and outputted.

To be more specific, firstly, the CPU 204 of the UP-DPI 141 extracts the IP Address (or the ID) of the S-GW and the MME, and the user identifier (IMSI) stored in the session record (Step 1801), and determines the user group to which the extracted IMSI belongs (Step 1802). Then, the CPU 204 of the UP-DPI 141 the file to which the session record is outputted for each pair of the S-GW 131, the MME 132, and the user group, and outputs the session record to the file (Step 1803). Finally, the CPU 204 of the UP-DPI 141 determines the traffic management server 143 which processes the session record file created for each pair of the S-GW 131, the MME 132, and the user group, and transfers the session record file created for each pair of the S-GW 131, the MME 132, and the user group to the traffic management server 143 (Step 1804).

Note that it is preferable to execute the file transfer process of Step 1804 in a periodical manner, or in a predetermined interval of time when a predetermined number of records have been accumulated and when other conditions have been satisfied. Also, the packet detail analysis apparatuses 141 and 142 may be configured to store therein only the file while the traffic management server 143 may be configured to transfer the files.

While an example in which the signaling records and the session records are sorted and outputted to separated files for each group of the S-GW 131, the MME 132, and the user group is described, signaling records and the session records may be outputted in a format different from that which is described above so long as the UP-DPI 141 and the CP-DPI 142 process the signaling records and the session records in a manner sorted by the groups of the S-GW 131, the MME 132, and the user group.

As described above, according to the third embodiment of the present invention, as the output from the DPIs 141 and 142 are further detailed, it becomes possible to further subdivide the output from the DPIs 141 and 142, reduce the load of the search process by the traffic management server 143 and increase the number of parallel processing.

### Fourth Embodiment

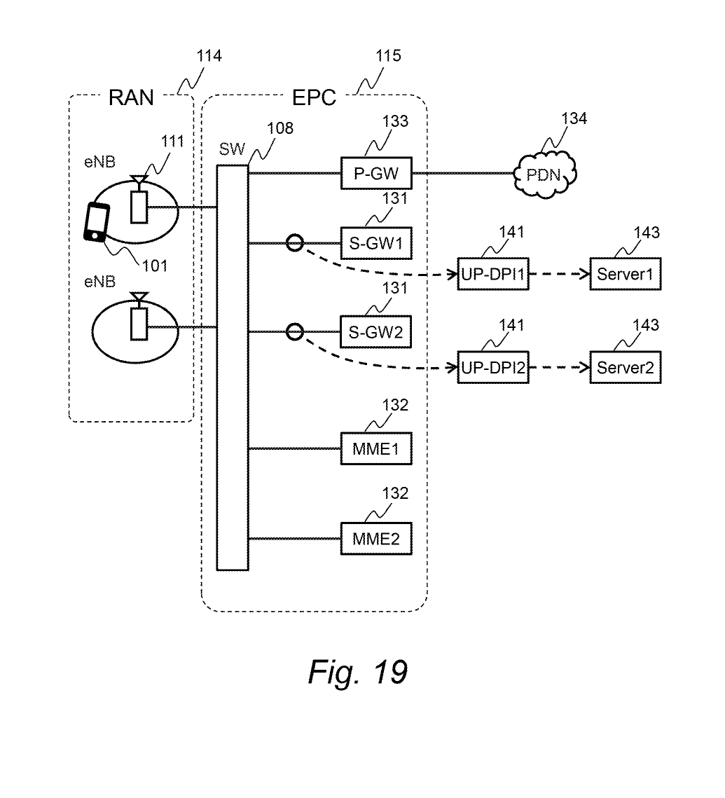

A fourth embodiment of the present invention will be described with reference to FIG. 19 through FIG. 26. The fourth embodiment is different from the first, second and the third embodiments in that the system configuration omits the packet detail analysis apparatus CP-DPI 142 and the detail of the process by the UP-DPI 141 is different from those according to the first, second and the third embodiments. Note that for the description of the fourth embodiment only the difference between the fourth embodiment and the above described first, second, and third embodiments will be described, where the same reference numerals as those used for the first, the second, and the third embodiments will be used denote the same configuration and process while the description thereof will be omitted. The first, the second, and the third embodiments may be problematic in that since the signaling records and the session records are corrected with one another so as to identify the application that was the cause for generating signaling, while the accuracy of identifying the cause is high so is the processing load. According to the fourth embodiment, the processing load will be reduced in a case where lowering the accuracy of identifying the application that is the cause for generating signaling is acceptable.

FIG. 19 illustrates a configuration of the cellular communication system according to the fourth embodiment.

The cellular communication system according to the fourth embodiment includes the eNodeB 111, which is a base station apparatus; the S-GW 131 and the P-GW 133, which are gateway apparatus; the MME 132, which is a communication control apparatus; the UP-DPI 141, which is a packet detail analysis apparatus; and the traffic management server 143. The eNodeB 111 will be connected with a UE 101, which is a user terminal.

Compared to the system according to the first embodiment, the system according to the fourth embodiment does not include the CP-DPI 142. The traffic management server 143 is connected with the UP-DPI 141. According to the present embodiment, the UP-DPI 141 is arranged for each S-GW so as to acquire the traffic transferred at the reference point S1-U and the S11. Note, however, that one UP-DPI 141 may accommodate therein a plurality of S-GWs 131, or a plurality of the UP-DPIs 141 may accommodate therein a single S-GW 131.

The outline of the flow of the data processing according to the fourth embodiment may be briefly described as the following. That is, the UP-DPI 141 acquires the signaling of the S11, estimates and manages the network connection status of the UE 101 by using the acquired signaling, gives a signaling generation cause flag (correlation subject flag) to the session immediately after being in a connection status with the network, and transmits the same to the traffic management server 143. The traffic management server 143 executes a statistical processing with respect to the session records that are set with the signaling generation cause flag (correlation subject flag) for visualization.

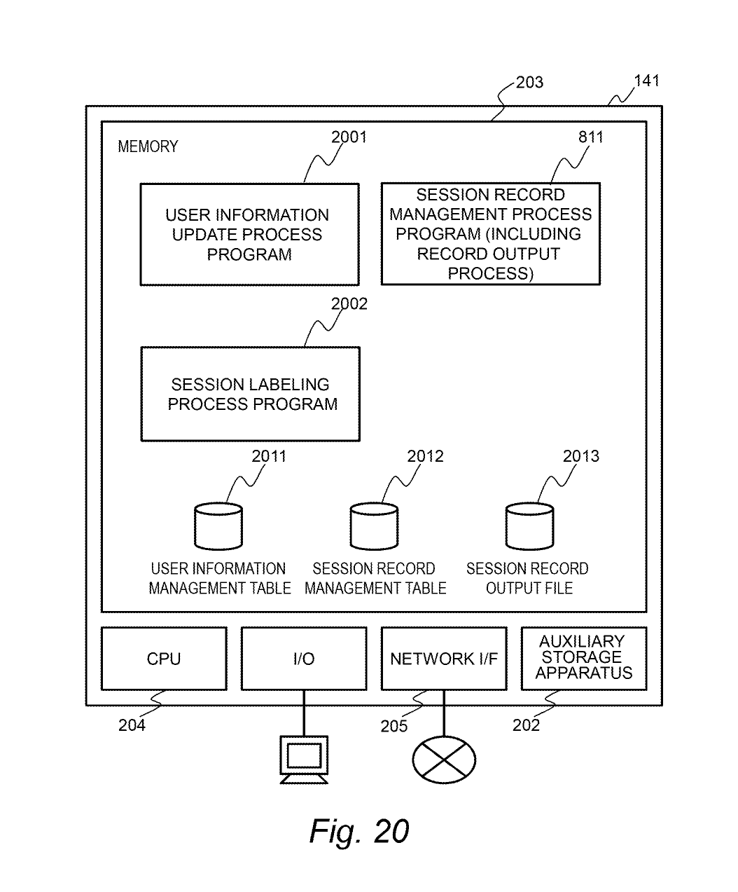

FIG. 20 illustrates a configuration of the packet detail analysis apparatus (UP-DPI) 141 according to the fourth embodiment.

Note that the UP-DPI 141 of the fourth embodiment is different from that in the first, the second, and the third embodiments in the following 4 aspects.

(1) User information update process program 2001: a portion is added to the user information update process program 211 of the first embodiment,

(2) Session labeling process program 2002 is added,

(3) User information management table 2011: a portion is added to the user information management table 221 of the first embodiment, and

(4) Session record management table 2012: a portion is added to the session record of the first embodiment.

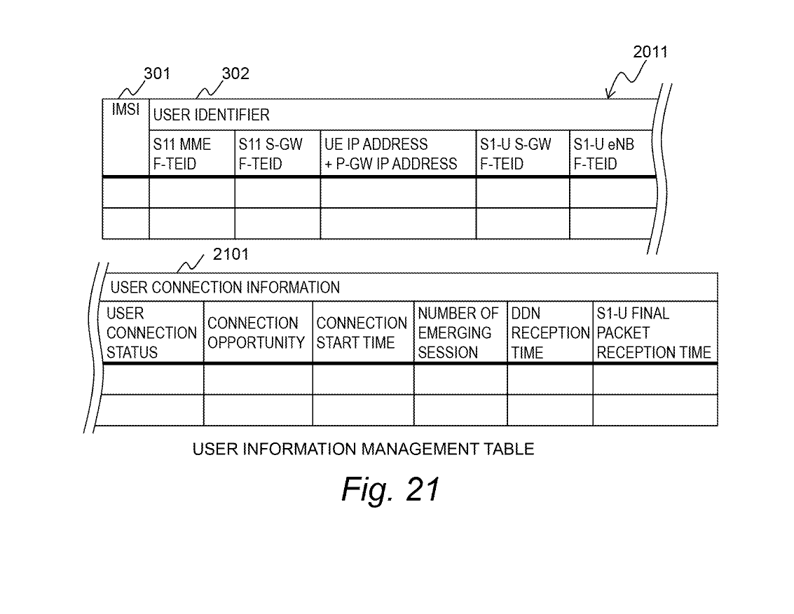

The details of each of these aspects will be described with reference to FIG. 21 to FIG. 26.

FIG. 21 illustrates an example of a configuration of the user information management table 2011 according to the fourth embodiment.

The user information management table 2011 includes an IMSI 301, the user identifier 302, and a user connection information 2101. The user information management table 2011 according to the fourth embodiment newly includes the user connection information 2101 to the user information management table 221 of the first embodiment. The user connection information 2101 includes a user connection status, a connection opportunity, a connection start time, a number of emerging session, a DDN reception time, and an S1-U final packet reception time.

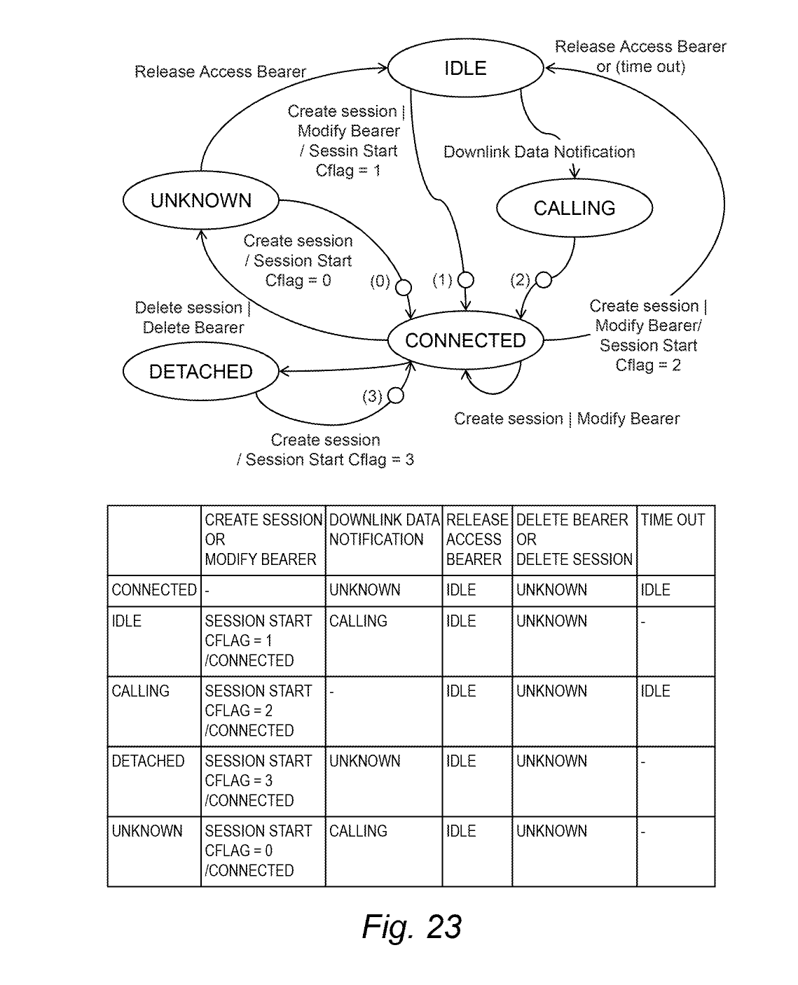

The user connection status stores therein the network connection status of an UE. For example, the user connection status includes a status such as “CONNECTED,” “IDLE,” “CALLING,” “DETACHED,” or “UNKNOWN,” which transitions based on the reception of signalings mainly by the S11. The details of the status transition will be described with reference to FIG. 23.

The connection opportunity, which includes the information related to the connection opportunity when the user connection status is “CONNECTED,” includes 4 variations: “user opportunity,” “network opportunity,” “location registration opportunity,” and “unknown.” In the description of the fourth embodiment the connection opportunity information is acquired before the status transitions to “CONNECTED.”

The connection start time stores therein time in which the status transitions to “CONNECTED.” The DDN reception time includes the DDN reception time stored at the S11. The S1-U final packet reception time stores therein the final packet reception time of the user packet. These time stamps are continuously overwritten so as to maintain the latest information. The number of emerging session stores therein the number of sessions transmitted and/or received by the UE.

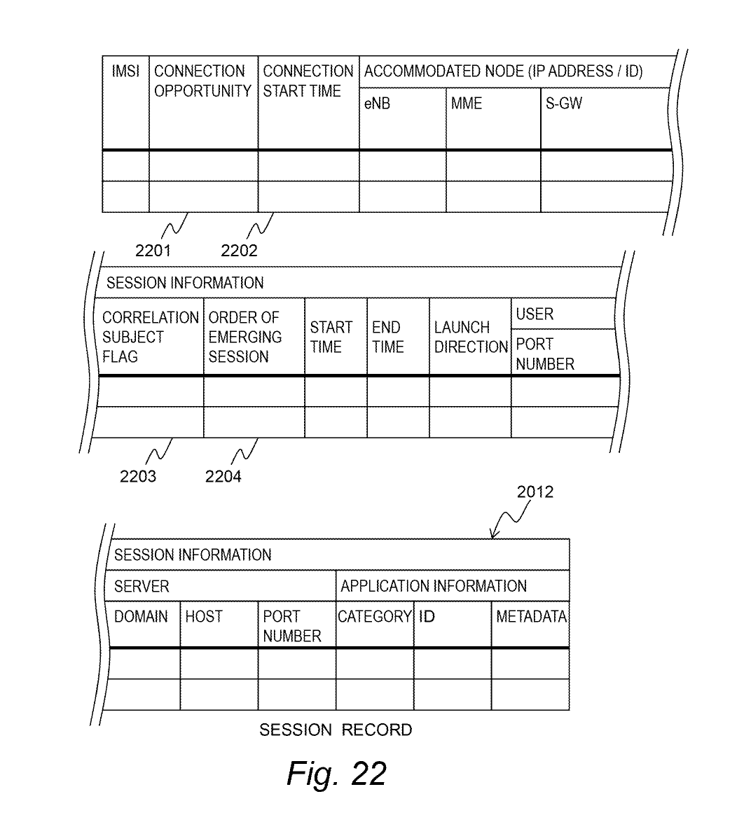

FIG. 22 illustrates an example of a configuration of the session record according to the fourth embodiment.

The session record includes the information included in the session record management table 2012 and a session record output file 2013. The session record management table 2012, which retains the information related to an ongoing session, in which search is conducted and is updated when the user traffic arrives. The session record output file 2013 retain the information related to a session that ended or a session which has identified an application.

The fourth embodiment includes a connection opportunity 2201, a connection start time 2202, a correlation subject flag 2203, and an order of emerging session 2204 newly added to the session record (FIG. 9) according to the first embodiment. The connection opportunity 2201 and the connection start time 2202, which include the information that is stored at the user connection information 2101 of the user information management table 2011, are acquired from the user information management table 2011 at the start of the session and stored therein. The correlation subject flag 2203 stores therein flag information indicating whether or not the session includes a cause for generating signaling. The order of emerging session 2204 stores therein the number of sessions transmitted and/or received by the UE after the connection start time 2202 and before the emergence of the session.

FIG. 23 illustrates a transition diagram regarding a user connection status managed at the UP-DPI 141 according to the fourth embodiment.

The user connection status includes a status such as “CONNECTED,” “IDLE,” “CALLING,” “DETACHED,” or “UNKNOWN,” which transitions based on the reception of signalings and timeout by the S11. The signaling used in the status transition includes Create Session, Modify Bearer, Downlink Data Notification, Release Access Bearer, Delete Bearer, and Delete Session.

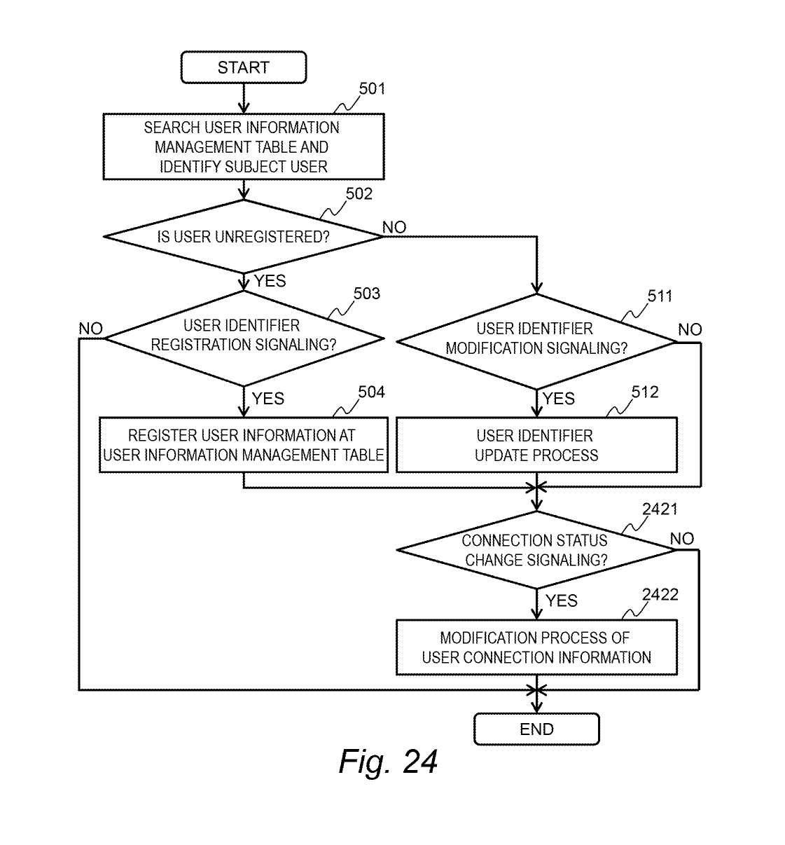

FIG. 24 is a flowchart of the user information update process according to the fourth embodiment. The user information update process illustrated in FIG. 24 is executed as the CPU 204 of the CP-DPI 142 executes the user information update process program 211.

Note that the processes of Step 501 through Step 512 are the same as those described in the first embodiment (FIG. 5), while the processes of Step 2421 and Step 2422 of the fourth embodiment are different from the processes described in the first embodiment. In Step 2421 and Step 2422 the user connection information 2101 of the user information management table 2011 is updated. To be more specific, in Step 2421 a determination will be made as to whether or not a status transition will occur based on the connection status of the UE 101 and received signaling of the S11. In Step 2422 the user connection status of the user information management table 2011 is updated. Further, in a case where the user connection status transitions to “CONNECTED” from “CALLING,” “DETACHED,” or “UNKNOWN,” the connection status and the connection start time are updated, and the number of emerging session is set as 0. The connection status stores therein “user opportunity (1),” “network opportunity (2),” “location registration opportunity (3),” and “unknown (0)” from the status prior to the transition. Also, the DDN reception time is updated when the DDN is transmitted.

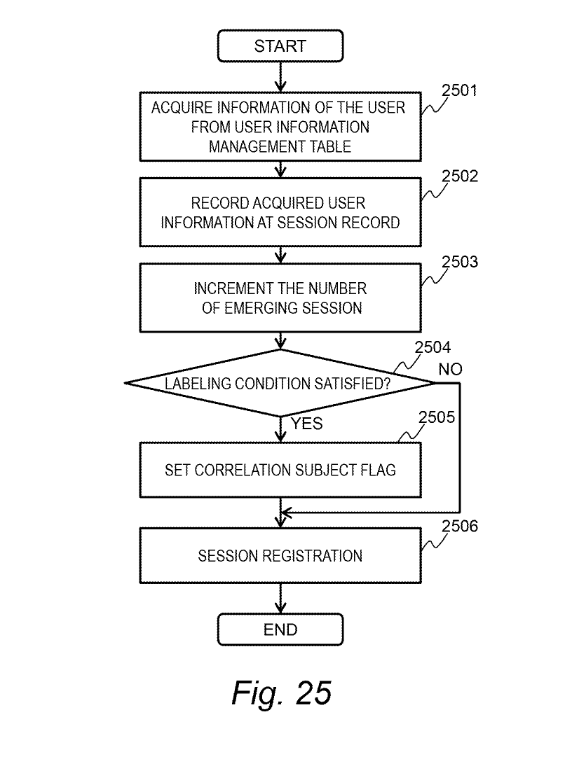

FIG. 25 is a flowchart of the session labeling process according to the fourth embodiment. The session labeling process illustrated in FIG. 25 is executed as the CPU 204 of the UP-DPI 141 executes the session labeling process program 2002.

The session labeling process program 2002, which includes a program that is executed during the session registration process (Step 1004 in FIG. 10) of the session record management process program 811, registers the field added to the session record in the fourth embodiment.

Firstly, the information of the UE 101 is acquired from the user information management table 2011, and the acquired information of the UE 101 is recorded at the session record (Step 2502). Next, the number of emerging session of the user information management table 2011 is incremented (Step 2503). Then, a determination will be made as to whether the session record created in Step 2501 satisfies a labeling condition (Step 2504). The labeling condition includes such as a time difference between the session start time 2202 and the session start time is within a certain amount of time, or the order of emerging session 2204 is below a predetermined threshold, or the like. Note that this condition may be arranged for each connection opportunity: in a case where the connection opportunity is “network opportunity,” the order of emerging session 2204 may be set below “1,” and when the connection opportunity is “user opportunity,” the order of emerging session 2204 may be set below “5,” for example. When it is determined in Step 2504 that the labeling condition is satisfied, the correlation subject flag of the session record is set (Step 2505), and the session record is registered (Step 2506).

Note that in order to reduce the processing load of the UP-DPI 141, the application identification process (Step 1006 and Step 1007) may be executed only with respect to the session to which the correlation subject flag has been set in the session record management process (FIG. 8).

The traffic management server 143 according to the fourth embodiment is configured to regard the session record, which is an output of the UP-DPI 141, as an input for the statistical processing rather than executing the record correlation process.

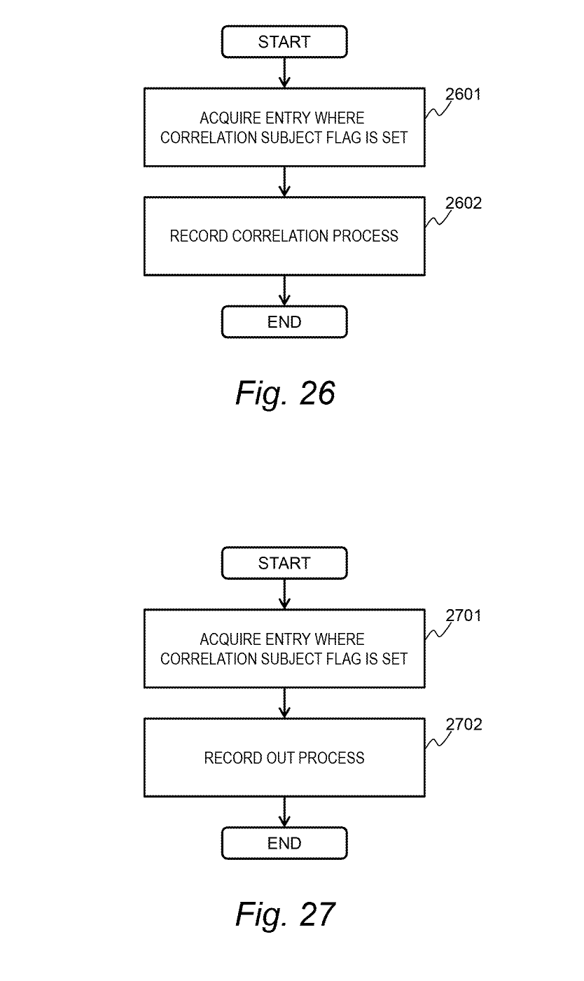

Note that the fourth embodiment may be combined with any of the first, the second, and/or the third embodiment. That is, the UP-DPI 141 according to the fourth embodiment may be applied to the UP-DPI 141 according to the first, the second, and/or the third embodiment. When each embodiment is combined with one another, the number of the session records that execute the record correlation process may be reduced, whereby the processing load of the record correlation process by the traffic management server is reduced. The traffic management server in such environment will be described with reference to FIG. 26.

FIG. 26 is a flowchart of the record correlation process according to a configuration in which the fourth embodiment is combined with the first embodiment, the second embodiment, or the third embodiment. The record correlation process illustrated in FIG. 26 is executed as the CPU 204 of the traffic management server 143 executes the record correlation process program 1101.

According to the fourth embodiment, unlike the first, the second, and the third embodiments, the process of Step 2601 is executed prior to the acquisition of the session record. In Step 2601 an entry in which the correlation subject flag is set in the session record is extracted. Then, in Step 2602, the record correlation process (Step 1401 through 1407) which is described with reference to FIG. 14 is executed.

As described above, according to the fourth embodiment, it becomes possible to select only the session log that is within a predetermined period of time since the status became “CONNECTED,” whereby the number of search by the traffic management server 143 is reduced and the load of the process to identify the application that is the cause for generating signaling is reduced.

### Fifth Embodiment

A fifth embodiment of the present invention will be described with reference to FIG. 27. The fifth embodiment enables the reduction of the volume of data transmission since only the record set with the correlation subject flag is outputted from the UP-DPI 141.

FIG. 27 is a flowchart of the record output process according to the fifth embodiment. The record output process illustrated in FIG. 27 is executed as the CPU 204 of the CP-DPI 142 or the UP-DPI 141 executes the signaling record generation process program 212 when the CP-DPI 142 outputs the signaling record and when the UP-DPI 141 outputs the session record.

According to the fifth embodiment, unlike the first, the second, and the third embodiments, the process of Step 2701 is executed prior to the output of the record. Firstly, in Step 2701, the session record that is set with the correlation subject flag is extracted. Then, in Step 2702, the record output process which is described in the first, the second, and the third embodiments (FIG. 7, FIG. 17, and FIG. 18) is executed.

As described above, according to the fifth embodiment of the present invention it becomes possible to reduce the volume of data transmission between the DPI 141 and the traffic management server 143.

As described above, according to the embodiments of the present invention, since a first monitoring apparatus (CP-DPI 142) monitors the control signal related to connection request between a user terminal (UE 101) and a network, and creates a reception log; a second monitoring apparatus (UP-DPI 141) monitors the packet inputted to and/or outputted from the gateway apparatus (S-GW 131) configured to transfer user data, sorts the packet per session, identifies the type of application which generates sessions, generates a session log which includes the type of application; and the traffic management server 143 acquires the reception log generated by the CP-DPI 142 and the session log generated by the UP-DPI 141, correlates the reception log and the session log with one another by using a time of occurrence of the reception log, a time of occurrence of the session log, and the identifier of the UE 101, and identifies the application related to the session which generated the control signal, it becomes possible to identify the application that caused the signaling, and, by displaying a statistical display, provide an operator with the information which includes the application, host, domain, or that like, that frequently generate signalings.

Also, since the CP-DPI 142 sorts the reception log for each user group to which the UE 101 belongs, and outputs accordingly, the UP-DPI 141 sorts the session log for each user group, and outputs accordingly, and the traffic management server acquires the reception log and the session log that are sorted for each user group, and correlates the reception log and the session log in accordance with the user group, it becomes possible to equalize the processing load on the DPs 141 and 143. In particular, in a case where the load on the S-GW 131 and the MME 132 are biased, or in a case where neither the S-GW 131 nor the MME 132 is connected in full mesh, the processing load on the DPs 141 and 143 are equalized.

Also, since the CP-DPI 142 outputs the reception log by sorting it for each pair of the S-GW 131 and the communication apparatus (MME 132), the UP-DPI 141 outputs the session log by sorting it for each pair of the S-GW 131 and the MME 132, and the traffic management server 143 acquires the reception log and the session log that are sorted for each pair of the gateway apparatus and the communication apparatus, and correlates the reception log and the session log with one another in accordance with the pair of the gateway apparatus and the communication apparatus, it becomes possible to adjust to the increase in the number of DPIs that accompanies the expansion of the network in a flexible manner.

Also, since the CP-DPI 142 outputs the reception log by sorting it for each group of the S-GW 131, MME 132, and the user group, the UP-DPI 141 outputs the session log by sorting it for each group of the S-GW 131, the MME 132, and the user group, and the traffic management server 143 acquires the reception log and the session log that are sorted for each group of the S-GW 131, MME 132, and the user group, and correlates the reception log and the session log with one another in accordance with the group of the S-GW 131, MME 132, and the user group, it becomes possible to further subdivide the output by the DPIs 141 and 142, reduce the load of the search process by the traffic management server 143 and increase the number of parallel processing.

Also, since the UP-DPI 141 estimates the connection status of the UE 101 from the control signal that is transmitted and/or received by the UE 101, gives a label to the session log that is generated within a predetermined period of time since the change in the connection status, and output the same, and the traffic management server 143 acquires the session log having given the label, and correlates the session log having given the label with the reception log, it becomes possible to select only the session log that is within the predetermined period of time since the status became “CONNECTED,” whereby the number of search by the traffic management server 143 is reduced and the load of the process to identify the application that is the cause for generating signaling is reduced.

Also, since the UP-DPI 141 estimates the connection status of the UE 101 from the control signal that is transmitted and/or received by the UE 101, and outputs the session log that is generated within a predetermined period of time since the change in the connection status, it becomes possible to reduce the volume of data transmission between the DPI 141 and the traffic management server 143.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. A communication system comprising:
a first monitoring apparatus configured to monitor a control signal related to a connection request between a network and a terminal, and generate a reception log;
a second monitoring apparatus configured to monitor a packet inputted to and outputted from a gateway apparatus configured to transfer user data, sort the packet for each session, identify a type of an application which generates the session, and generate a session log including the type of an application; and
a traffic management server configured to acquire the reception log generated by the first monitoring apparatus and the session log generated by the second monitoring apparatus, correlate the reception log with the session log by using an occurrence time of the reception log, an occurrence time of the session log, and an identifier of the terminal, and identify an application related to a session which generated the control signal.

2. The communication system according to claim 1, wherein
the first monitoring apparatus is configured to sort the reception log for each user group the terminal belongs, and outputs the reception log,
the second monitoring apparatus is configured to sort the session log for each of the user group, and output the session log,
the traffic management server is configured to acquire the reception log and the session log sorted for each of the user group, and
the traffic management server is configured to correlate the reception log with the session log according to the user group.

3. The communication system according to claim 1, wherein
the communication system further comprises a communication apparatus configured to process the control signal related to the connection request,
the first monitoring apparatus is configured to sort the reception log for each pair of the gateway apparatus and the communication apparatus, and outputs the reception log,
the second monitoring apparatus is configured to sort the session log for each of the pair of the gateway apparatus and the communication apparatus, and output the session log,
the traffic management server is configured to acquire the reception log and the session log sorted for each of the pair of the gateway apparatus and the communication apparatus, and
the traffic management server is configured to correlate the reception log with the session log sorted for each of the pair of the gateway apparatus and the communication apparatus.

4. The communication system according to claim 1, wherein
the communication system includes a communication apparatus configured to process the control signal related to the connection request,
the first monitoring apparatus is configured to sort the reception log for each group of the gateway apparatus, the communication apparatus, and a user group, and output the reception log,
the second monitoring apparatus is configured to sort the session log for each of the group of the gateway apparatus, the communication apparatus, and the user group, and outputs the session log,
the traffic management server is configured to acquire the reception log and the session log sorted for each of the group of the gateway apparatus, the communication apparatus, and the user group, and
the traffic management server correlate the reception log with the session log sorted for each of the group of the gateway apparatus, the communication apparatus, and the user group.

5. The communication system according to claim 1, wherein
the second monitoring apparatus is configured to estimate a connection status of the terminal from a control signal transmitted and received by the terminal, give a label to a session log generated within a predetermined period of time since a change in the connection status, and output the session log, and
the traffic management server is configured to acquire the session log having the label, and correlate the session log having the label with the reception log.

6. The communication system according to claim 1, wherein the second monitoring apparatus is configured to estimate a connection status of the terminal from a control signal transmitted and received by the terminal, and output a session log generated within a predetermined period of time since a change in the connection status.

7. A management server comprising
a storage unit which stores a program and
a processor which executes the program stored in the storage unit,
the management server being configured to acquire a reception log outputted from a first monitoring apparatus configured to monitor a control signal related to a connection request between a network and a terminal configuring a communication system,
the management server being configured to acquire a session log outputted from a second monitoring apparatus configured to monitor a packet inputted and outputted by a gateway apparatus configured to transfer user data, sort the packet for each session, and identify a type of an application which generates the session,
the management server being configured to correlate the reception log with the session log by using an occurrence time of the reception log, an occurrence time of the session log, and an identifier of the terminal, and
the server identify an application related to a session which generated the control signal.

8. The management server according to claim 7, wherein
the second monitoring apparatus is configured to estimate a connection status of the terminal from a control signal transmitted and received by the terminal, give a label to a session log generated within a predetermined period of time since a change in the connection status, and output the session log, and
the management server is configured to acquire the session log having the label, and correlate the session log having the label with the reception log.

9. The management server according to claim 7, wherein
the first monitoring apparatus is configured to sort the reception log for each user group the terminal belongs, and outputs the reception log,
the second monitoring apparatus is configured to sort the session log for each of the user group, and outputs the session log,
the traffic management server is configured to acquire the reception log and the session log sorted for each of the user group, and
the traffic management server is configured to correlate the reception log with the session log according to the user group.

10. The management server according to claim 7, wherein
the communication system includes a communication apparatus configured to process the control signal related to the connection request,
the first monitoring apparatus is configured to sort the reception log for each group of the gateway apparatus, the communication apparatus, and a user group, and outputs the reception log,
the second monitoring apparatus is configured to sort the session log for each of the group of the gateway apparatus, the communication apparatus, and the user group, and outputs the session log,
the traffic management server is configured to acquire the reception log and the session log sorted for each of the group of the gateway apparatus, the communication apparatus, and the user group, and
the traffic management server is configured to correlate the reception log with the session log sorted for each of the group of the gateway apparatus, the communication apparatus, and the user group.

11. A monitoring apparatus configured to monitor a packet inputted and outputted by a gateway apparatus in a communication system,
the monitoring apparatus comprising
a storage unit which stores a program and
a processor which executes the program stored in the storage unit,
the monitoring apparatus being configured to sort the packet for each session,
the monitoring apparatus being configured to identify a type of an application which generates the session,
the monitoring apparatus being configured to generate a session log for the session for each user group, and
the monitoring apparatus being configured to output the generated session log to a traffic management server to correlate a reception log for monitoring a control signal related to a connection request between a network and a terminal configuring the communication system with the generated session log.

12. The monitoring apparatus according to claim 11, wherein
the communication system includes a communication apparatus configured to process the control signal related to the connection request, and
the monitoring apparatus is configured to generate the session log for each group of the gateway apparatus, the communication apparatus, and a user group.

13. The monitoring apparatus according to claim 11, wherein the monitoring apparatus is configured to estimates a connection status of the terminal from a control signal transmitted and received by the terminal, give a label to a session log generated within a predetermined period of time since a change in the connection status, and output the session log.

14. The monitoring apparatus according to claim 11, wherein
the monitoring apparatus is configured to estimate a connection status of the terminal from a control signal transmitted and received by the terminal, and
the monitoring apparatus is configured to output a session log generated within a predetermined period of time since a change in the connection status.
